(19) United States
(12) Patent Application Publication
(10) Pub. No.: US 2011/0009064 A1
(43) Pub. Date: Jan. 13, 2011

(54) WIRELESS COMMUNICATION APPARATUS AND WIRELESS COMMUNICATION METHOD

(75) Inventors: Chiharu Yamazaki, Kanagawa (JP); Shigeru Kimura, Kanagawa (JP); Fangwei Tong, Kanagawa (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/810,500

(22) PCT Filed: Dec. 5, 2008
(86) PCT No.: PCT/JP2008/072131

§ 371 Date: Sep. 30, 2010

(30) Foreign Application Priority Data
Dec. 26, 2007 (JP) 2007-334692
Dec. 26, 2007 (JP) 2007-334696

(51) Int. Cl. H04B 15/00; H04B 7/00

(52) U.S. Cl. 455/63.1

(57) ABSTRACT

A wireless communication apparatus 100 according to the present invention is provided with a reception channel coefficient variation calculation unit 130-1, . . . for calculating a variation of a reception channel coefficient calculated by a reception channel coefficient calculation unit 120-1, . . . , a transmission channel coefficient calculation unit 140-1, . . . for calculating a transmission channel coefficient at transmission by extrapolation based on the variation of the reception channel coefficient, a correction coefficient memory unit 150-1 for storing a correction coefficient based on the variation of the reception channel coefficient at reception for correcting the transmission channel coefficient at transmission, and a correction unit 170-11, . . . for correcting the transmission channel coefficient at transmission calculated by the transmission channel coefficient calculation unit 140-1, . . . based on the correction coefficient stored in the correction coefficient memory unit 150-1.

### CROSS REFERENCE TO RELATED APPLICATION

This application claims priority to and the benefit of Japanese Patent Application No. 2007-334692 (filed on Dec. 26, 2007) and Japanese Patent Application No. 2007-334696 (filed on Dec. 26, 2007), the entire contents of which are incorporated herein by reference.

### TECHNICAL FIELD

The present invention relates to wireless communication apparatus having a plurality of antennas, and wireless communication methods for controlling wireless communication between a wireless communication apparatus having a plurality of antennas and a counterpart wireless communication apparatus.

### BACKGROUND ART

As an adaptive control of an array weight at transmission performed by a wireless communication apparatus having a plurality of antennas and using different frequency bands at transmission and reception, there is a method to calculate the array weight by estimating a channel coefficient at transmission by an extrapolation process such as a linear extrapolation based on a variation of a channel coefficient at reception (for example, Patent Document 1). In addition, as the adaptive control of the array weight in a transmission frequency band performed by a wireless communication apparatus having a plurality of antennas and using different frequency bands at transmission and reception, there is a method to calculate the array weight by estimating a channel coefficient in a transmission frequency band by the extrapolation process such as the linear extrapolation based on a variation of a channel coefficient in a reception frequency band in a frequency direction (for example, Patent Document 1). More specifically, when a reception channel coefficient (absolute value) changes from a point p11 to a point p12 shown in FIG. 9, it is estimated (calculated) that a transmission channel coefficient (absolute value) is at a point p13 in FIG. 9, based on the change of the reception channel coefficient.

Patent Document 1: Japanese Patent No. 3644594

### SUMMARY OF INVENTION

### Technical Problem

However, when the channel coefficient at transmission or the channel coefficient in the transmission frequency band is estimated by the extrapolation process according to the above conventional art, it may cause a significant difference between the transmission channel coefficient estimated and an actual transmission channel coefficient due to fluctuation conditions of the channel coefficient at reception or of the channel coefficient in the reception frequency band. For example, when the reception channel coefficient (absolute value) changes from a point p21 to a point p22 as shown in FIG. 10 and thus the transmission channel coefficient (absolute value) is estimated (calculated) to be at a point p23 in FIG. 10 based on the change of the reception channel coefficient, an actual transmission channel coefficient (absolute value) may be, however, at a point p24 in FIG. 10, which causes a significant estimation error corresponding to a difference between the points p23 and p24 as shown in the figure.

A first object of the present invention is to provide techniques (wireless communication apparatus and wireless communication methods) which improve calculation accuracy of a transmission channel coefficient at transmission when calculating the transmission channel coefficient at transmission from a reception channel coefficient at reception, by correcting the transmission channel coefficient at transmission based on a correction coefficient in consideration of the variation of the reception channel coefficient at reception.

A second object of the present invention is to provide techniques (wireless communication apparatus and wireless communication methods) which improve calculation accuracy of a transmission channel coefficient in a transmission frequency band when calculating the transmission channel coefficient in the transmission frequency band from a reception channel coefficient in a reception frequency band, by correcting the transmission channel coefficient in the transmission frequency band based on a correction coefficient in consideration of the variation of the reception channel coefficient in the reception frequency band.

### Solution to Problem

In order to achieve the above first object, a wireless communication apparatus having a plurality of antennas according to the present invention includes: a reception channel coefficient calculation unit for calculating a reception channel coefficient at reception, for each of the plurality of antennas; a transmission channel coefficient calculation unit for calculating a transmission channel coefficient at transmission, for each of the plurality of antennas, by extrapolation based on a variation of the reception channel coefficient at reception calculated by the reception channel coefficient calculation unit; and a correction unit for correcting the transmission channel coefficient at transmission calculated by the transmission channel coefficient calculation unit, using a correction coefficient based on the variation of the reception channel coefficient at reception.

The wireless communication apparatus according to one embodiment of the present invention is characterized in that the correction coefficient is a correction coefficient for more reducing an absolute value of the transmission channel coefficient at transmission calculated by the transmission channel coefficient calculation unit, based on a larger variation of an absolute value of the reception channel coefficient at reception.

The wireless communication apparatus according to another embodiment of the present invention is characterized in that the correction coefficient is a correction coefficient for correcting a phase of the transmission channel coefficient at transmission calculated by the transmission channel coefficient calculation unit in a same direction as a direction of a phase variation of the reception channel coefficient at reception.

The wireless communication apparatus according to yet another embodiment of the present invention is characterized in that the correction unit corrects the transmission channel coefficient at transmission calculated by the transmission channel coefficient calculation unit, further based on the reception channel coefficient at reception calculated by the reception channel coefficient calculation unit.

The wireless communication apparatus according to yet another embodiment of the present invention is characterized in that the correction coefficient is a correction coefficient for more reducing an absolute value of the transmission channel coefficient at transmission calculated by the transmission channel coefficient calculation unit, based on a larger absolute value of the reception channel coefficient at reception calculated by the reception channel coefficient calculation unit.

The wireless communication apparatus according to yet another embodiment of the present invention is characterized in further including a reception channel coefficient memory unit for storing a plurality of reception channel coefficients at reception calculated by the reception channel coefficient calculation unit, a reception channel coefficient distribution calculation unit for calculating a distribution of reception channel coefficients based on the plurality of reception channel coefficients at reception stored in the reception channel coefficient memory unit, and a correction coefficient calculation unit for calculating a correction coefficient for correcting the transmission channel coefficient at transmission calculated by the transmission channel coefficient calculation unit, based on the distribution of reception channel coefficients calculated by the reception channel coefficient distribution calculation unit, and the correction unit corrects the transmission channel coefficient at transmission calculated by the transmission channel coefficient calculation unit based on the correction coefficient calculated by the correction coefficient calculation unit.

The wireless communication apparatus according to yet another embodiment of the present invention is characterized in that the correction coefficient calculation unit calculates a correction coefficient for more reducing an absolute value of the transmission channel coefficient at transmission calculated by the transmission channel coefficient calculation unit, based on a larger variation of an absolute value of the reception channel coefficient at reception.

The wireless communication apparatus according to yet another embodiment of the present invention is characterized in that the correction coefficient calculation unit calculates a correction coefficient for correcting a phase of the transmission channel coefficient at transmission calculated by the transmission channel coefficient calculation unit in a same direction as a direction of a phase variation of the reception channel coefficient at reception.

The wireless communication apparatus according to yet another embodiment of the present invention is characterized in that the correction coefficient calculation unit calculates a correction coefficient for more reducing an absolute value of the transmission channel coefficient at transmission calculated by the transmission channel coefficient calculation unit, based on a larger absolute value of the reception channel coefficient at reception calculated by the reception channel coefficient calculation unit.

In order to achieve the above second object, a wireless communication apparatus having a plurality of antennas according to the present invention includes: a reception channel coefficient calculation unit for calculating a reception channel coefficient in a reception frequency band, for each of the plurality of antennas; a transmission channel coefficient calculation unit for calculating a transmission channel coefficient in a transmission frequency band, for each of the plurality of antennas, by extrapolation based on a variation of the reception channel coefficient in the reception frequency band calculated by the reception channel coefficient calculation unit; and a correction unit for correcting the transmission channel coefficient in the transmission frequency band calculated by the transmission channel coefficient calculation unit, using a correction coefficient based on the variation of the reception channel coefficient in the reception frequency band.

The wireless communication apparatus according to one embodiment of the present invention is characterized in that the correction coefficient is a correction coefficient for more reducing an absolute value of the transmission channel coefficient in the transmission frequency band calculated by the transmission channel coefficient calculation unit, based on a larger variation of an absolute value of the reception channel coefficient in the reception frequency band in a frequency direction.

The wireless communication apparatus according to another embodiment of the present invention is characterized in that the correction coefficient is a correction coefficient for correcting a phase of the transmission channel coefficient in the transmission frequency band calculated by the transmission channel coefficient calculation unit in a same direction as a direction of a phase variation of the reception channel coefficient in the reception frequency band in a frequency direction.

The wireless communication apparatus according to yet another embodiment of the present invention is characterized in that the correction unit corrects the transmission channel coefficient in the transmission frequency band calculated by the transmission channel coefficient calculation unit, further based on the reception channel coefficient in the reception frequency band calculated by the reception channel coefficient calculation unit.

The wireless communication apparatus according to yet another embodiment of the present invention is characterized in that the correction coefficient is a correction coefficient for more reducing an absolute value of the transmission channel coefficient in the transmission frequency band calculated by the transmission channel coefficient calculation unit, based on a larger absolute value of the reception channel coefficient in the reception frequency band calculated by the reception channel coefficient calculation unit.

The wireless communication apparatus according to yet another embodiment of the present invention is characterized in further including a reception channel coefficient memory unit for storing a plurality of reception channel coefficients in the reception frequency band calculated by the reception channel coefficient calculation unit, a reception channel coefficient distribution calculation unit for calculating a distribution of reception channel coefficients in a frequency direction based on the plurality of reception channel coefficients in the reception frequency band stored in the reception channel coefficient memory unit, and a correction coefficient calculation unit for calculating a correction coefficient for correcting the transmission channel coefficient in the transmission frequency band calculated by the transmission channel coefficient calculation unit, based on the distribution of reception channel coefficients in the frequency direction calculated by the reception channel coefficient distribution calculation unit, and the correction unit corrects the transmission channel coefficient in the transmission frequency band calculated by the transmission channel coefficient calculation unit based on the correction coefficient calculated by the correction coefficient calculation unit.

The wireless communication apparatus according to yet another embodiment of the present invention is characterized in that the correction coefficient calculation unit calculates a correction coefficient for more reducing an absolute value of the transmission channel coefficient in the transmission frequency band calculated by the transmission channel coefficient calculation unit, based on a larger variation of an absolute value of the reception channel coefficient in the reception frequency band in the frequency direction.

The wireless communication apparatus according to yet another embodiment of the present invention is characterized in that the correction coefficient calculation unit calculates a correction coefficient for correcting a phase of the transmission channel coefficient in the transmission frequency band calculated by the transmission channel coefficient calculation unit in a same direction as a direction of a phase variation of the reception channel coefficient in the reception frequency band in the frequency direction.

The wireless communication apparatus according to yet another embodiment of the present invention is characterized in that the correction coefficient calculation unit calculates a correction coefficient for more reducing an absolute value of the transmission channel coefficient in the transmission frequency band calculated by the transmission channel coefficient calculation unit, based on a larger absolute value of the reception channel coefficient in the reception frequency band calculated by the reception channel coefficient calculation unit.

The wireless communication apparatus according to yet another embodiment of the present invention is characterized in that the wireless communication apparatus is used for a system in which the transmission frequency band and the reception frequency band are different from each other.

In order to achieve the above first object, a wireless communication method according to the present invention for controlling wireless communication between a wireless communication apparatus having a plurality of antennas and a counterpart wireless communication apparatus includes: a reception channel coefficient calculation step for calculating a reception channel coefficient at reception, for each of the plurality of antennas; a transmission channel coefficient calculation step for calculating a transmission channel coefficient at transmission, for each of the plurality of antennas, by extrapolation based on a variation of the reception channel coefficient at reception calculated at the reception channel coefficient calculation step; and a correction step for correcting the transmission channel coefficient at transmission calculated at the transmission channel coefficient calculation step, using a correction coefficient based on the variation of the reception channel coefficient at reception.

In order to achieve the above second object, a wireless communication method according to the present invention for controlling wireless communication between a wireless communication apparatus having a plurality of antennas and a counterpart wireless communication apparatus includes: a reception channel coefficient calculation step for calculating a reception channel coefficient in a reception frequency band, for each of the plurality of antennas; a transmission channel coefficient calculation step for calculating a transmission channel coefficient in a transmission frequency band, for each of the plurality of antennas, by extrapolation based on a variation of the reception channel coefficient in the reception frequency band calculated at the reception channel coefficient calculation step; and a correction step for correcting the transmission channel coefficient in the transmission frequency band calculated at the transmission channel coefficient calculation step, using a correction coefficient based on the variation of the reception channel coefficient in the reception frequency band.

### Advantageous Effects on Invention

According to the present invention, the correction unit corrects the transmission channel coefficient at transmission calculated by the transmission channel coefficient calculation unit, using the correction coefficient based on the variation of the reception channel coefficient at reception stored in the correction coefficient memory unit. Thereby, it is possible to reduce a calculation error (estimation error) of the transmission channel coefficient. Accordingly, it is possible to provide techniques (wireless communication apparatus and wireless communication methods) which improve calculation accuracy of the transmission channel coefficient at transmission.

According to the present invention, the correction unit corrects the transmission channel coefficient in the transmission frequency band calculated by the transmission channel coefficient calculation unit, using the correction coefficient based on the variation of the reception channel coefficient in the reception frequency band stored in the correction coefficient memory unit. Thereby, it is possible to reduce the calculation error (estimation error) of the transmission channel coefficient. Accordingly, it is possible to provide techniques (wireless communication apparatus and wireless communication methods) which improve calculation accuracy of the transmission channel coefficient in the transmission frequency band.

### BRIEF DESCRIPTION OF DRAWINGS

FIG. 1 is a block diagram illustrating a schematic constitution of a wireless communication apparatus according to a first embodiment applying a wireless communication method of the present invention;

FIG. 2 is a diagram illustrating a relationship between an absolute value error of a transmission channel coefficient and an absolute value variation of a reception channel coefficient at reception, for explaining a correction coefficient used for correcting the transmission channel coefficient at transmission by the wireless communication apparatus according to the first embodiment;

FIG. 3 is a block diagram illustrating a schematic constitution of a wireless communication apparatus according to a second embodiment applying the wireless communication method of the present invention;

FIG. 4 is a diagram illustrating a relationship between the absolute value error of the transmission channel coefficient and the absolute value variation of the reception channel coefficient at reception, for explaining the correction coefficient used for correcting the transmission channel coefficient at transmission by the wireless communication apparatus according to the second embodiment;

FIG. 5 is a diagram illustrating a relationship between an offset component and the absolute value of the reception channel coefficient at reception, for explaining the correction coefficient used for correcting the transmission channel coefficient at transmission by the wireless communication apparatus according to the second embodiment;

FIG. 6 is a block diagram illustrating a schematic constitution of a wireless communication apparatus according to a third embodiment applying the wireless communication method of the present invention;

FIGS. 7(a), (b) are diagrams illustrating relationships between a phase error of the transmission channel coefficient and a phase variation of the reception channel coefficient at reception, for explaining the correction coefficient used for correcting the transmission channel coefficient at transmission by the wireless communication apparatus according to the third embodiment;

FIG. 8 is a block diagram illustrating a schematic constitution of a wireless communication apparatus according to a fourth embodiment applying the wireless communication method of the present invention;

FIG. 9 is a diagram for explaining a conventional art to estimate the transmission channel coefficient by an extrapolation process;

FIG. 10 is a diagram for explaining a significant estimation error by the conventional art which estimates the transmission channel coefficient by the extrapolation process;

FIG. 11 is a block diagram illustrating a schematic constitution of a wireless communication apparatus according to a fifth embodiment applying the wireless communication method of the present invention;

FIG. 12 is a diagram illustrating a relationship between the absolute value error of the transmission channel coefficient and the absolute value variation of the reception channel coefficient in a reception frequency band, for explaining the correction coefficient used for correcting the transmission channel coefficient in a transmission frequency band by the wireless communication apparatus according to the fifth embodiment;

FIG. 13 is a block diagram illustrating a schematic constitution of a wireless communication apparatus according to a sixth embodiment applying the wireless communication method of the present invention;

FIG. 14 is a diagram illustrating a relationship between the absolute value error of the transmission channel coefficient and the absolute value variation of the reception channel coefficient in the reception frequency band, for explaining the correction coefficient used for correcting the transmission channel coefficient in the transmission frequency band by the wireless communication apparatus according to the sixth embodiment;

FIG. 15 is a diagram illustrating a relationship between the offset component and the absolute value of the reception channel coefficient in the reception frequency band, for explaining the correction coefficient used for correcting the transmission channel coefficient in the transmission frequency band by the wireless communication apparatus according to the sixth embodiment;

FIG. 16 is a block diagram illustrating a schematic constitution of a wireless communication apparatus according to a seventh embodiment applying the wireless communication method of the present invention;

FIGS. 17(a), (b) are diagrams illustrating relationships between the phase error of the transmission channel coefficient and the phase variation of the reception channel coefficient in the reception frequency band, for explaining the correction coefficient used for correcting the transmission channel coefficient in the transmission frequency band by the wireless communication apparatus according to the seventh embodiment; and

FIG. 18 is a block diagram illustrating a schematic constitution of a wireless communication apparatus according to an eighth embodiment applying the wireless communication method of the present invention.

### DESCRIPTION OF EMBODIMENTS

Embodiments of the present invention will be described with reference to the accompanying drawings.

### First Embodiment

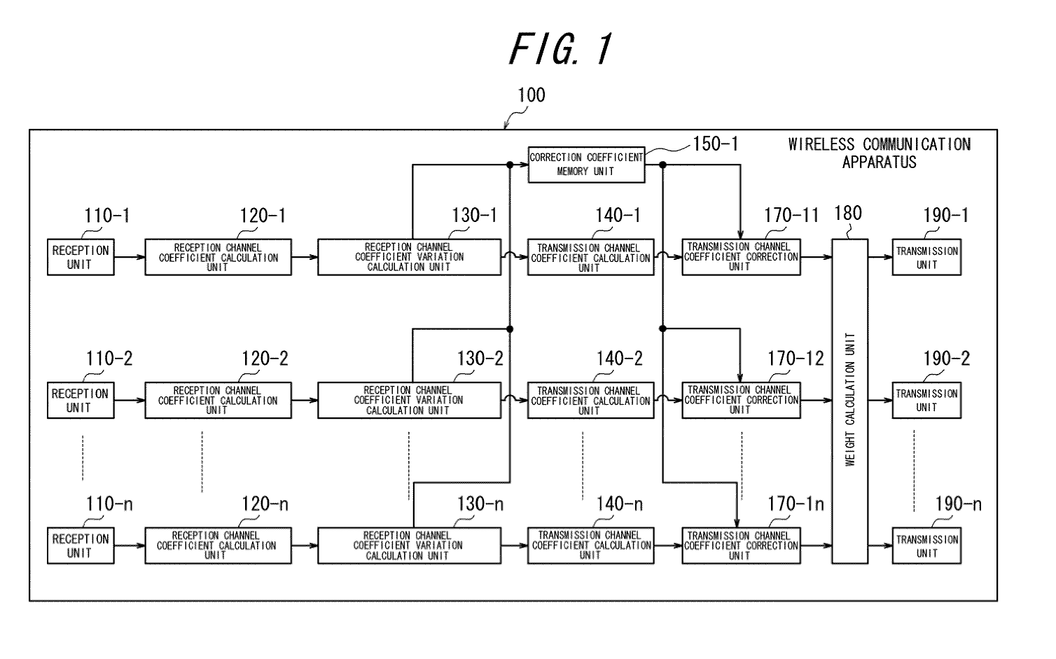

FIG. 1 is a block diagram illustrating a schematic constitution of a wireless communication apparatus according to a first embodiment applying a wireless communication method of the present invention. A wireless communication apparatus 100 according to the present embodiment is a wireless communication apparatus (hereinafter referred to also as a base station) having a plurality of antennas (not shown). The wireless communication apparatus 100 is provided with reception units 110-1 and 110-2 to 110-n for receiving radio signals transmitted from a counterpart wireless communication apparatus (not shown, hereinafter referred to also as a terminal) via a plurality of antennas, reception channel coefficient calculation units 120-1 and 120-2 to 120-n for calculating reception channel coefficients at reception (reception channel coefficients at reception of the respective plurality of antennas) in relation to the counterpart wireless communication apparatus based on the signals received by the reception units 110-1 and 110-2 to 110-n, reception channel coefficient variation calculation units 130-1 and 130-2 to 130-n for calculating variations of the reception channel coefficients at reception, respectively, calculated by the reception channel coefficient calculation units 120-1 and 120-2 to 120-n (wherein the variation includes a variation of an absolute value of the reception channel coefficient and a variation of a phase of the reception channel coefficient), transmission channel coefficient calculation units 140-1 and 140-2 to 140-n for calculating (estimating) transmission channel coefficients at transmission (transmission channel coefficients at transmission of the respective plurality of antennas) by extrapolation (linear extrapolation, for example) in relation to the counterpart wireless communication apparatus based on the variations of the reception channel coefficients at reception calculated by the reception channel coefficient variation calculation units 130-1 and 130-2 to 130-n, a correction coefficient memory unit 150-1 for storing a correction coefficient for correcting the transmission channel coefficients at transmission calculated by the transmission channel coefficient calculation units 140-1 and 140-2 to 140-n, transmission channel coefficient correction units 170-11 and 170-12 to 170-1n for correcting the transmission channel coefficients at transmission calculated by the transmission channel coefficient calculation units 140-1 and 140-2 to 140-n, a weight calculation unit 180 for calculating weights based on the transmission channel coefficients corrected by the transmission channel coefficient correction units 170-11 and 170-12 to 170-1n, and transmission units 190-1 and 190-2 190-n for transmitting radio signals, based on the transmission channel coefficients corrected by the transmission channel coefficient correction units 170-11 and 170-12 to 170-1n and the weights calculated by the weight calculation unit 180, via the plurality of antennas.

The correction coefficient memory unit 150-1 stores the correction coefficient, for correcting the transmission channel coefficients at transmission calculated by the transmission channel coefficient calculation units 140-1 and 140-2 to 140-n, based on the variations of the reception channel coefficients at reception calculated by the reception channel coefficient variation calculation units 130-1 and 130-2 to 130-n.

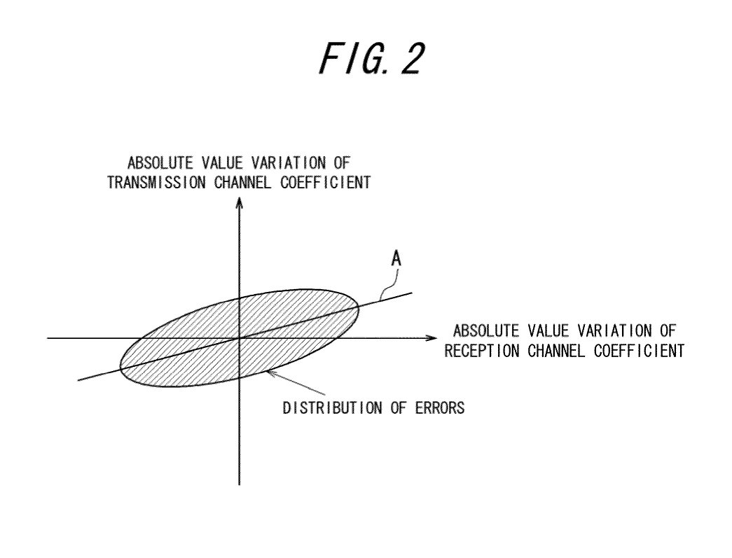

According to the present embodiment, the variation of the absolute value of the reception channel coefficient at reception (variation of the absolute value including a positive sign and a negative sign) is used as the variation of the reception channel coefficient at reception. In addition, according to the present embodiment, as the correction coefficient, a slope of an approximate straight line (derivative) A shown in FIG. 2 is used, which corresponds to “a correction coefficient for more reducing the absolute value of the transmission channel coefficient at transmission calculated by each of the transmission channel coefficient calculation units 140-1 and 140-2 and 140-n, based on a larger variation of the absolute value of the reception channel coefficient at reception”.

The transmission channel coefficient correction units 170-11 and 170-12 to 170-1n correct the transmission channel coefficients at transmission calculated by the transmission channel coefficient calculation units 140-1 and 140-2 and 140-n, using the correction coefficient based on the variations of the reception channel coefficients at reception (in this case, variations of absolute values of the reception channel coefficients at reception) and stored in the correction coefficient memory unit 150-1.

Next, a correcting operation of the transmission channel coefficient according to the first embodiment is explained.

Under circumstances with a number of scattering objects such as in an urban area, the reception channel coefficient at reception between the wireless communication apparatus (base station) 100 and the counterpart wireless communication apparatus (terminal) varies more significantly with time as being influenced by fading. When the variation of the reception channel coefficient at reception is adequately small, the transmission channel coefficient at transmission, which is estimated from the variation of the reception channel coefficient at reception by use of the linear extrapolation, is well matched with an original channel coefficient at transmission. With significant influence by fading, however, the transmission channel coefficient at transmission calculated (estimated) by the linear extrapolation departs far from the original transmission channel coefficient at transmission, causing a significant calculation error (estimation error).

The following is an explanation of a relationship between the calculation error (estimation error) of the transmission channel coefficient and the reception channel coefficient at reception, based on FIG. 2. In FIG. 2, a horizontal axis indicates a variation of an absolute value component of the reception channel coefficient at reception and a vertical axis indicates an error between the absolute value component of the transmission channel coefficient at transmission calculated (estimated) by the linear extrapolation stated above and the absolute value component of the original transmission channel coefficient at transmission. An oval area indicates a distribution of errors of absolute values of the transmission channel coefficients. The approximate straight line A shown in FIG. 2 can be obtained by assuming that there is a linear relationship between the error and the absolute value variation of the reception channel coefficient at reception as shown in FIG. 2.

It is possible to calculate (estimate) the transmission channel coefficients at transmission highly accurately, by storing the slope of the approximate straight line A (derivative) as the correction coefficient in the correction coefficient memory unit 150-1 in advance and using the correction coefficient, together with the variations of absolute values of the reception channel coefficients at reception calculated by the reception channel coefficient variation calculation units 130-1 and 130-2 to 130-n, for correction of the transmission channel coefficients by the transmission channel coefficient correction units 170-11 and 170-12 to 170-1n. This correction uses the following formula (1).

$$\begin{matrix}[ Formula 1 ] & \\ \vert {H}_{TX} \vert = \vert {\hat{H}}_{TX} \vert - α \frac{\partial \vert {H}_{RX} \vert}{\partial t} & ( 1 )\end{matrix}$$

provided that
   |H_{TX}|: absolute value of transmission channel coefficient after correction
   |Ĥ_{TX}|: absolute value of transmission channel coefficient before correction
α: correction coefficient to variation of absolute value of reception channel coefficient at reception

$$\frac{\partial \vert {H}_{RX} \vert}{\partial t} \text{:}$$

variation of absolute value of reception channel coefficient at reception

According to the first embodiment, it is possible to reduce the calculation error (estimation error) of the transmission channel coefficient by correcting the absolute value of the transmission channel coefficient at transmission calculated (estimated) by the extrapolation (the linear extrapolation, for example) based on the variation of the reception channel coefficient at reception, by use of the correction coefficient based on the variation of the reception channel coefficient at reception shown in FIG. 2. Thereby, even under circumstances with a significant fluctuation of the channel coefficient because of rapid movement of the counterpart wireless communication apparatus (terminal), it is possible to reduce the calculation error (estimation error) of the transmission channel coefficient, which improves calculation accuracy (estimation accuracy) of the transmission channel coefficient at transmission. Accordingly, it is possible to obtain good communication quality by preventing deterioration of communication quality caused by the fluctuation of the channel coefficient because of rapid movement and the likes of the counterpart wireless communication apparatus (terminal).

### Second Embodiment

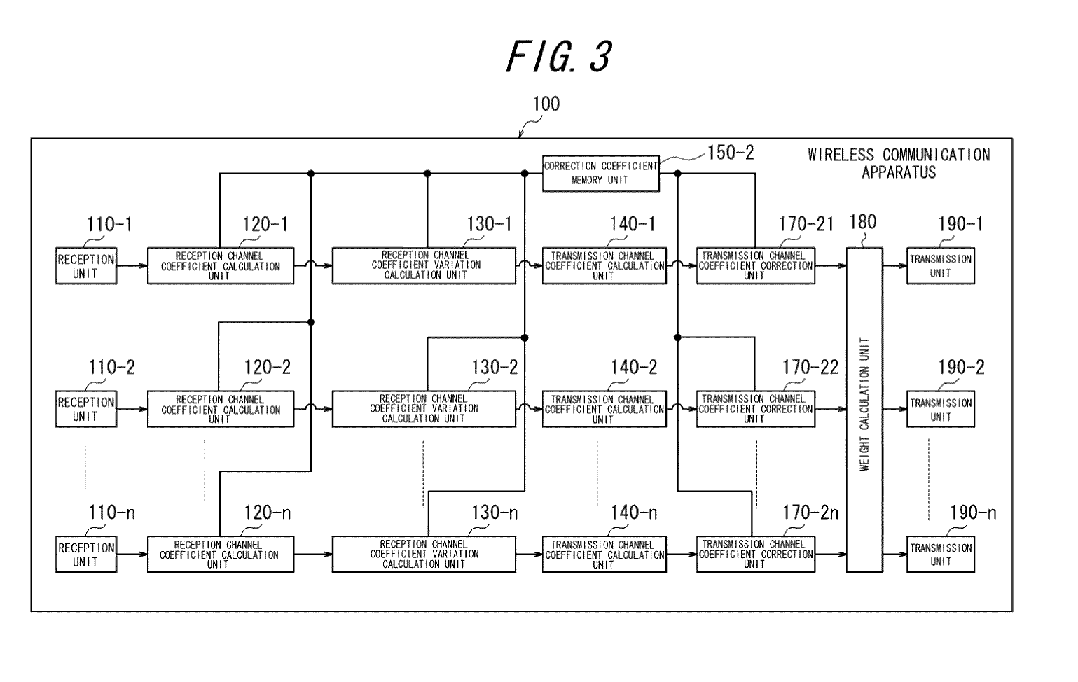

FIG. 3 is a block diagram illustrating a schematic constitution of a wireless communication apparatus according to a second embodiment applying the wireless communication method of the present invention. A wireless communication apparatus 100 according to the present embodiment has the same constitution as the wireless communication apparatus 100 of the first embodiment, except for replacing the correction coefficient memory unit 150-1 with a correction coefficient memory unit 150-2 and also replacing the transmission channel coefficient correction units 170-11 and 170-12 to 170-1n with transmission channel coefficient correction units 170-21 and 170-22 to 170-2n.

The correction coefficient memory unit 150-2 stores correction coefficients based on the variations of the reception channel coefficients at reception calculated by the reception channel coefficient variation calculation units 130-1 and 130-2 to 130-n and the reception channel coefficients at reception calculated by the reception channel coefficient calculation units 120-1 and 120-2 to 120-n, for correcting the transmission channel coefficients at transmission calculated by the transmission channel coefficient calculation units 140-1 and 140-2 to 140-n.

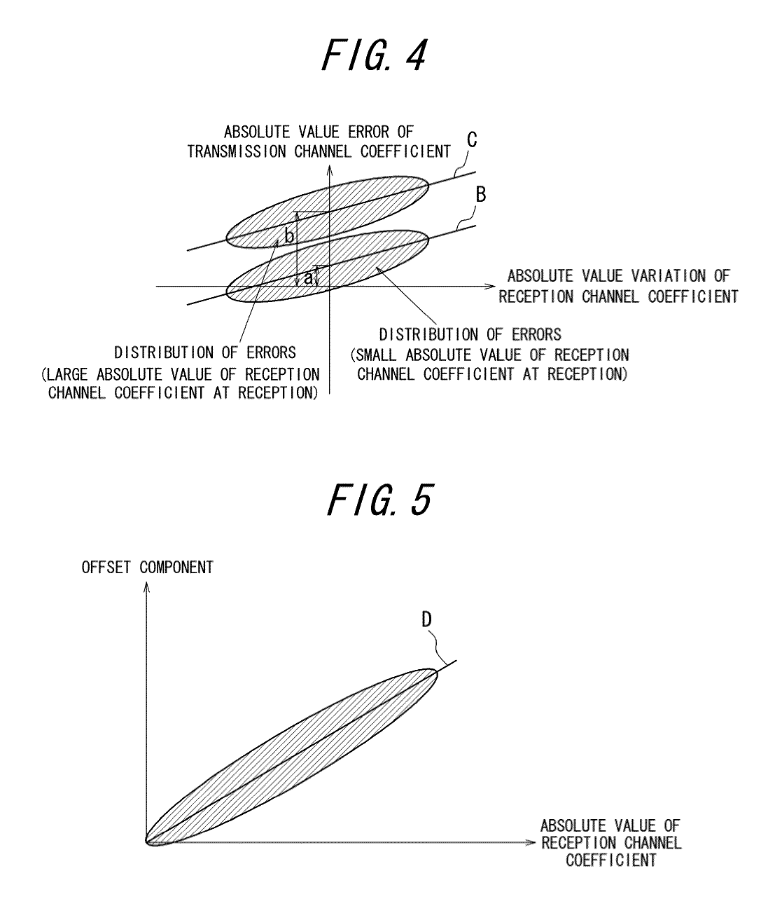

According to the present embodiment, a variation of the absolute value of the reception channel coefficient at reception (variation of the absolute value including the positive sign and the negative sign) is used as the variation of the reception channel coefficient at reception. In addition, according to the present embodiment, slops (derivatives) of approximate straight lines B and C shown in FIG. 4 and an approximate straight line D shown in FIG. 5 are used as the correction coefficients, which correspond to “a correction coefficient for more reducing the absolute value of the transmission channel coefficient at transmission calculated by each of the transmission channel coefficient calculation units 140-1 and 140-2 and 140-n, based on a larger variation of the absolute value of the reception channel coefficient at reception” and “a correction coefficient for more reducing the absolute value of the transmission channel coefficient at transmission calculated by each of the transmission channel coefficient calculation units 140-1 and 140-2 and 140-n, based on a larger absolute value of the reception channel coefficient at reception calculated by each of the reception channel coefficient calculation units 120-1 and 120-2 to 120-n”. In FIG. 4, the distribution of errors in the lower part indicates a distribution of absolute value errors of the transmission channel coefficients at transmission when absolute values of the reception channel coefficients at reception are small, while the distribution of errors in the upper part indicates a distribution of absolute value errors of the transmission channel coefficients at transmission when absolute values of the reception channel coefficients at reception are large.

The transmission channel coefficient correction units 170-21 and 170-22 to 170-2n correct the transmission channel coefficients at transmission calculated by the transmission channel coefficient calculation units 140-1 and 140-2 to 140-n using correction coefficients based on the variations of the reception channel coefficients at reception and the reception channel coefficients at reception and stored in the correction coefficient memory unit 150.

Next, the correcting operation of the transmission channel coefficient according to the second embodiment is described.

Under circumstances with a number of scattering objects such as in the urban area, the reception channel coefficient at reception between the wireless communication apparatus (base station) 100 and the counterpart wireless communication apparatus (terminal) varies more significantly with time as being influenced by fading. When the variation of the reception channel coefficient at reception is adequately small, the transmission channel coefficient at transmission, which is estimated from the variation of the reception channel coefficient at reception by use of the linear extrapolation, is well matched with an original channel coefficient at transmission. With significant influence by fading, however, the transmission channel coefficient at transmission calculated (estimated) by the linear extrapolation departs far from the original transmission channel coefficient at transmission, causing a significant calculation error (estimation error).

The following is a description of the relationship between the calculation error (estimation error) of the transmission channel coefficient and the reception channel coefficient at reception, based on FIG. 4. In FIG. 4, the horizontal axis indicates the variation of the absolute value component of the reception channel coefficient at reception and the vertical axis indicates the error between the absolute value component of the transmission channel coefficient at transmission calculated (estimated) by the linear extrapolation stated above and the absolute value component of the original transmission channel coefficient at transmission. One of two oval areas indicates the distribution of absolute value errors of the transmission channel coefficients when the absolute values of the reception channel coefficients at reception are small, while the other indicates the distribution of absolute value errors of the transmission channel coefficients when the absolute values of the reception channel coefficients at reception are large. Approximate straight lines B and C shown in FIG. 4 can be obtained by assuming that there is a linear relationship between the error and the absolute value variation of the reception channel coefficient at reception as shown in FIG. 4.

FIG. 5 shows a relationship between offset components (a and b in FIG. 4 indicating displacements from the approximate straight line passing an origin) of the approximate straight lines B and C and the absolute value of the reception channel coefficient at reception. The approximate straight line D shown in FIG. 5 can be obtained by assuming that there is a linear relationship between the absolute value of the reception channel coefficient at reception and the offset component, as shown in FIG. 5. It is possible to calculate (estimate) the transmission channel coefficients at transmission highly accurately, by storing the slopes (derivatives) of the approximate straight lines B, C and D as the correction coefficients in the correction coefficient memory unit 150-2 in advance and using the correction coefficients, together with the variations of the absolute values of the reception channel coefficients at reception calculated by the reception channel coefficient variation calculation units 130-1 and 130-2 to 130-n and the reception channel coefficients at reception calculated by the reception channel coefficient calculation units 120-1 and 120-2 to 120-n, for correction of the transmission channel coefficients by the transmission channel coefficient correction units 170-21 and 170-22 to 170-2n. This correction uses the following formula (2).

$$\begin{matrix}[ Formula 2 ] & \\ \vert {H}_{TX} \vert = \vert {\hat{H}}_{TX} \vert - α \frac{\partial \vert {H}_{RX} \vert}{\partial t} - β \vert {H}_{RX} \vert & ( 2 )\end{matrix}$$

provided that
   |H_{TX}|: absolute value of transmission channel coefficient after correction
   |Ĥ_{TX}|: absolute value of transmission channel coefficient before correction
α: correction coefficient to variation of absolute value of reception channel coefficient at reception

$$\frac{\partial \vert {H}_{RX} \vert}{\partial t} \text{:}$$

variation of absolute value of reception channel coefficient at reception
β: correction coefficient to absolute value of reception channel coefficient at reception
   |H_{RX}|: absolute value of reception channel coefficient at reception

According to the second embodiment, it is possible to reduce the calculation error (estimation error) of the transmission channel coefficient by correcting the absolute value of the transmission channel coefficient at transmission calculated (estimated) by the extrapolation (the linear extrapolation, for example) based on the variation of the reception channel coefficient at reception, by use of the correction coefficients based on the variation of the reception channel coefficient at reception and the reception channel coefficient at reception shown in FIGS. 4 and 5. Thereby, even under circumstances with the significant fluctuation of the channel coefficient because of rapid movement of the counterpart wireless communication apparatus (terminal), it is possible to reduce the calculation error (estimation error) of the transmission channel coefficient, which improves calculation accuracy (estimation accuracy) of the transmission channel coefficient at transmission. Accordingly, it is possible to obtain good communication quality by preventing deterioration of communication quality caused by the fluctuation of the channel coefficient because of rapid movement and the likes of the counterpart wireless communication apparatus (terminal).

### Third Embodiment

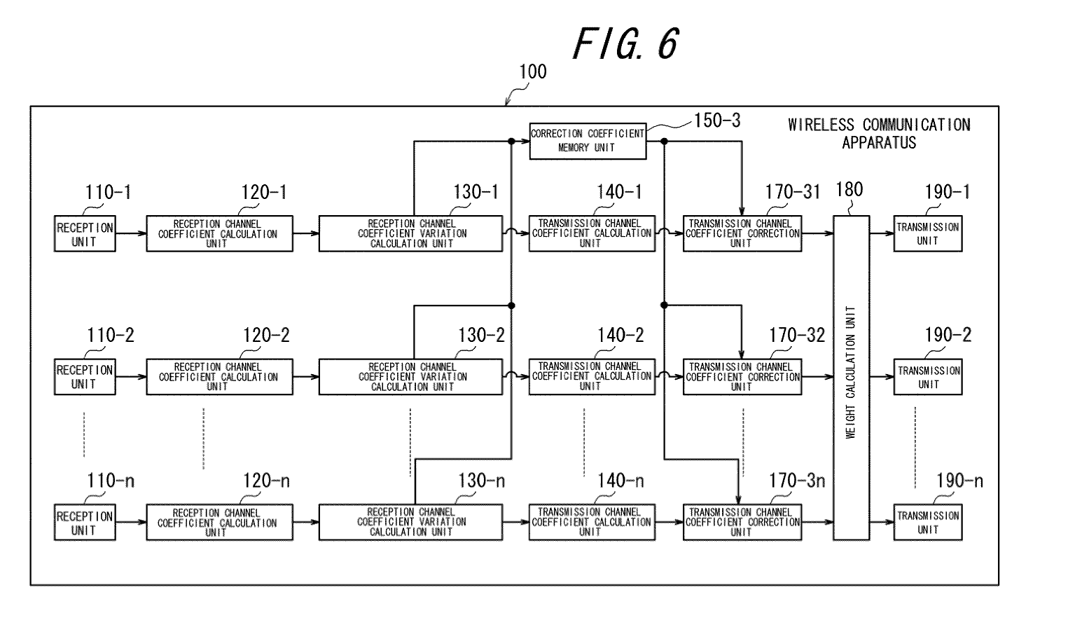

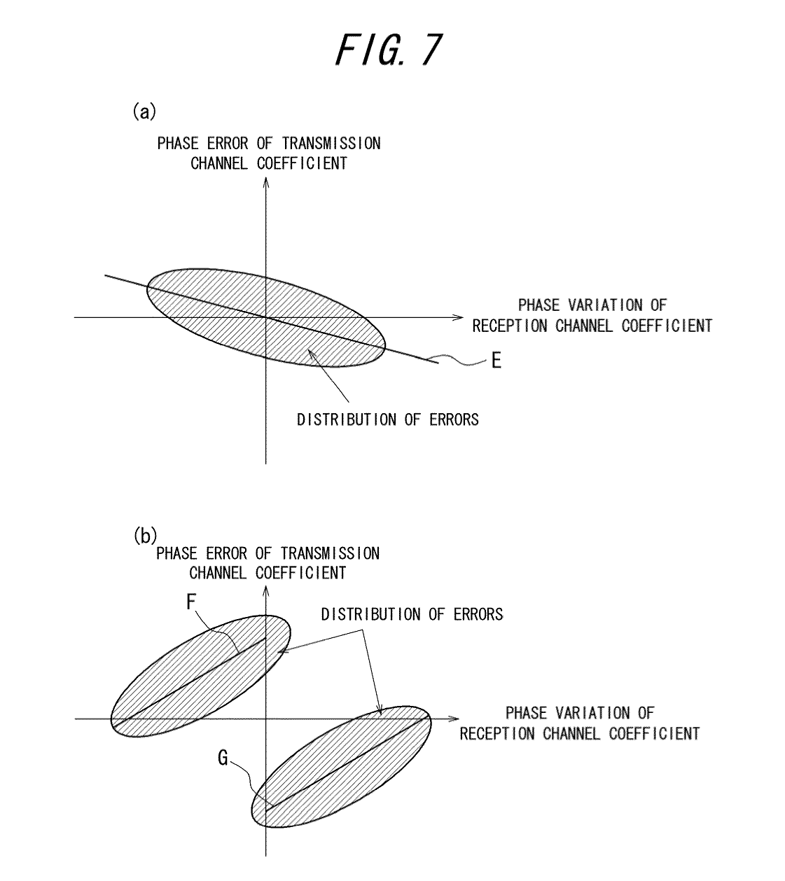

FIG. 6 is a block diagram illustrating a schematic constitution of a wireless communication apparatus according to a third embodiment applying the wireless communication method of the present invention. A wireless communication apparatus 100 according to the present embodiment has the same constitution as the wireless communication apparatus 100 of the first embodiment, except for replacing the correction coefficient memory unit 150-1 with a correction coefficient memory unit 150-3 and also replacing the transmission channel coefficient correction units 170-11 and 170-12 to 170-1n with transmission channel coefficient correction units 170-31 and 170-32 to 170-3n.

The correction coefficient memory unit 150-3 stores a correction coefficient based on the variations of the reception channel coefficients at reception calculated by the reception channel coefficient variation calculation units 130-1 and 130-2 to 130-n, for correcting the transmission channel coefficients at transmission calculated by the transmission channel coefficient calculation units 140-1 and 140-2 to 140-n.

According to the present embodiment, a phase variation of the reception channel coefficient at reception (phase variation including the positive sign and the negative sign) is used as the variation of the reception channel coefficient at reception. According to the present embodiment, slopes (derivatives) of approximate straight lines E, F and G shown in FIGS. 7(a), (b) are used as the correction coefficient, which correspond to “a correction coefficient for correcting the phase of the transmission channel coefficient at transmission calculated by each of the transmission channel coefficient calculation units 140-1 and 140-2 to 140-n, in the same direction as a direction of the phase variation of the reception channel coefficient at reception”.

The transmission channel coefficient correction units 170-31 and 170-32 to 170-3n correct the transmission channel coefficients at transmission calculated by the transmission channel coefficient calculation units 140-1 and 140-2 to 140-n, using the correction coefficient based on the variation of the reception channel coefficient at reception (in this case, the phase variation of the reception channel coefficient in a reception frequency band) stored in the correction coefficient memory unit 150-3.

Next, the correcting operation of the transmission channel coefficient according to the third embodiment is explained.

Under circumstances with a number of scattering objects such as in the urban area, the reception channel coefficient at reception between the wireless communication apparatus (base station) 100 and the counterpart wireless communication apparatus (terminal) varies more significantly with time as being influenced by fading. When the variation of the reception channel coefficient at reception is adequately small, the transmission channel coefficient at transmission, which is estimated from the variation of the reception channel coefficient at reception by use of the linear extrapolation, is well matched with an original channel coefficient at transmission. With significant influence by fading, however, the transmission channel coefficient at transmission calculated (estimated) by the linear extrapolation departs far from the original transmission channel coefficient at transmission, causing a significant calculation error (estimation error).

The following is a description of a relationship between the calculation error (estimation error) of the transmission channel coefficient and the reception channel coefficient at reception, based on FIGS. 7(a), (b). In FIGS. 7(a), (b), the horizontal axis indicates the variation of a phase component of the reception channel coefficient at reception and the vertical axis indicates the error between the phase component of the transmission channel coefficient at transmission calculated (estimated) by the linear extrapolation stated above and a phase component of the original transmission channel coefficient at transmission. FIG. 7(a) indicates a case where the phase variation of the reception channel coefficient increases and an oval area indicates a distribution of phase errors of the transmission channel coefficients. FIG. 7(b) indicates a case where the phase variation of the reception channel coefficient decreases and one of oval areas indicates a distribution of phase errors of the transmission channel coefficients when the phase errors are positive, while the other indicates a distribution of phase errors of the transmission channel coefficients when the phase errors are negative. The approximate straight line E shown in FIG. 7(a) can be obtained by assuming that there is a linear relationship between the error and the phase variation of the reception channel coefficient at reception as shown in FIG. 7(a).

It is possible to calculate (estimate) the transmission channel coefficients at transmission highly accurately, by storing a slope of the approximate straight line E (derivative) as the correction coefficient in the correction coefficient memory unit 150-3 in advance and using the correction coefficient, together with phase variations of the reception channel coefficients at reception calculated by the reception channel coefficient variation calculation units 130-1 and 130-2 to 130-n, for correction of the transmission channel coefficients by the transmission channel coefficient correction units 170-31 and 170-32 to 170-3n. This correction uses the following formula (3).

$$\begin{matrix}[ Formula 3 ] & \\ arg ( {H}_{TX} ) = arg ( {\hat{H}}_{TX} ) - α \frac{\partial arg ( {H}_{RX} )}{\partial t} & ( 3 )\end{matrix}$$

provided that
arg(H_{TX}): phase of transmission channel coefficient after correction
arg(Ĥ_{TX}): phase of transmission channel coefficient before correction
α: correction coefficient to phase variation of reception channel coefficient at reception
   (when variation of absolute value of reception channel coefficient at reception increases)

$$\frac{\partial arg ( {H}_{RX} )}{\partial t} \text{:}$$

phase variation of reception channel coefficient at reception

In addition, approximate straight lines F and G shown in FIG. 7(b) can be obtained, by assuming that there is the linear relationship between the error and the phase variation of the reception channel coefficient at reception as shown in FIG. 7(b).

It is possible to calculate (estimate) the transmission channel coefficients at transmission highly accurately, by storing the slopes of the approximate straight lines F and G (derivatives) as the correction coefficient in the correction coefficient memory unit 150-3 in advance and using the correction coefficient, together with phase variations of the reception channel coefficients at reception calculated by the reception channel coefficient variation calculation units 130-1 and 130-2 to 130-n, for correction of the transmission channel coefficients by the transmission channel coefficient correction units 170-31 and 170-32 to 170-3n. This correction uses the following formulas (4), (5).

$$\begin{matrix}[ Formula 4 ] & \\ arg ( {H}_{TX} ) = arg ( {\hat{H}}_{TX} ) + α \frac{\partial arg ( {H}_{RX} )}{\partial t} - β & ( 4 )\end{matrix}$$

(when phase variation of reception channel coefficient at reception increases)

$$\begin{matrix}[ Formula 5 ] & \\ arg ( {H}_{TX} ) = arg ( {\hat{H}}_{TX} ) - α \frac{\partial arg ( {H}_{RX} )}{\partial t} + β & ( 5 )\end{matrix}$$

(when phase variation of reception channel coefficient at reception decreases) provided that
arg(H_{TX}) : phase of transmission channel coefficient after correction
arg(Ĥ_{TX}): phase of transmission channel coefficient before correction
α: correction coefficient to phase variation of reception channel coefficient at reception
   (when variation of absolute value of reception channel coefficient at reception decreases)

$$\frac{\partial arg ( {H}_{RX} )}{\partial t} \text{:}$$

phase variation of reception channel coefficient at reception
β: offset of correction to phase variation of reception channel coefficient at reception
   (when variation of absolute value of reception channel coefficient at reception decreases)

According to the third embodiment, it is possible to reduce the calculation error (estimation error) of the transmission channel coefficient by correcting the phase of the transmission channel coefficient at transmission calculated (estimated) by the extrapolation (the linear extrapolation, for example) based on the variation of the reception channel coefficient at reception by use of the correction coefficient based on the variation of the reception channel coefficient at reception shown in FIGS. 7(a), (b). Thereby, even under circumstances with the significant fluctuation of the channel coefficient because of rapid movement of the counterpart wireless communication apparatus (terminal), it is possible to reduce the calculation error (estimation error) of the transmission channel coefficient, which improves calculation accuracy (estimation accuracy) of the transmission channel coefficient at transmission. Accordingly, it is possible to obtain good communication quality by preventing deterioration of communication quality caused by the fluctuation of the channel coefficient because of rapid movement and the likes of the counterpart wireless communication apparatus (terminal).

### Fourth Embodiment

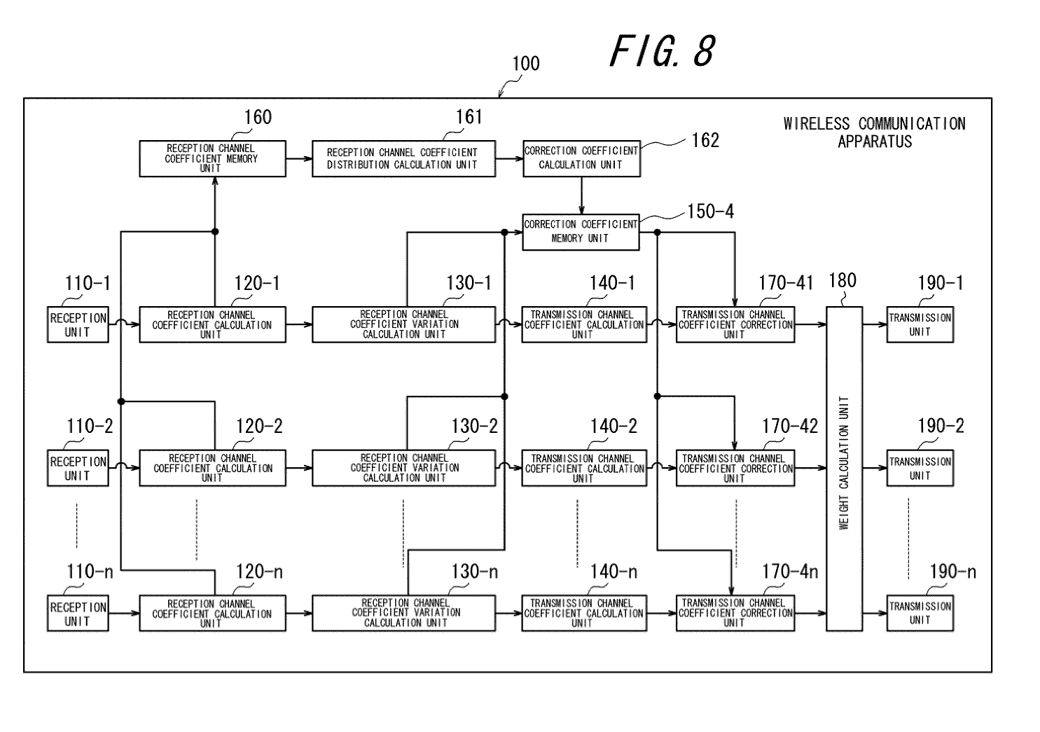

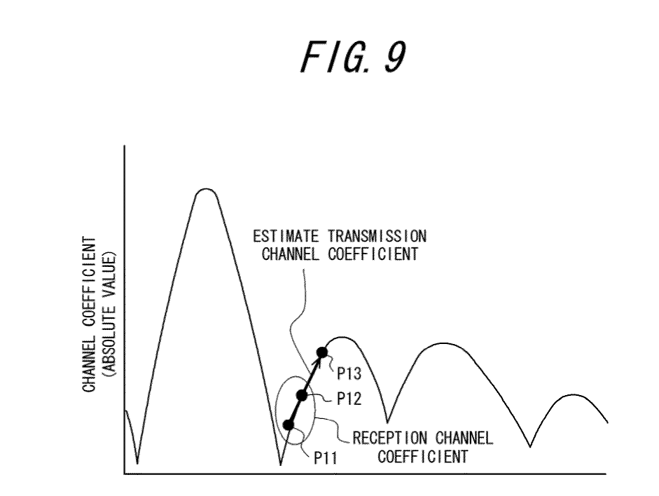

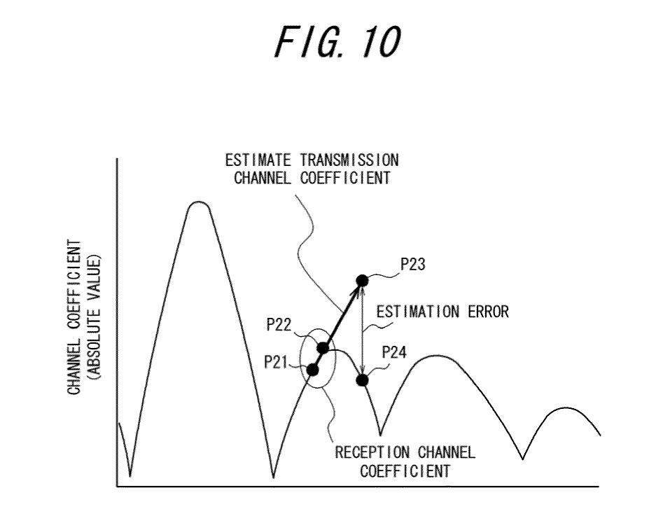

FIG. 8 is a block diagram illustrating a schematic constitution of a wireless communication apparatus according to a fourth embodiment applying the wireless communication method of the present invention. A wireless communication apparatus 100 according to the present embodiment has the same constitution as the wireless communication apparatus 100 of the first embodiment, except for having a reception channel coefficient memory unit 160, a reception channel coefficient distribution calculation unit 161 and a correction coefficient calculation unit 162 in addition and replacing the correction coefficient memory unit 150-1 with a correction coefficient memory unit 150-4 and also replacing the transmission channel coefficient correction units 170-11 and 170-12 to 170-1n with transmission channel coefficient correction units 170-41 and 170-42 to 170-4n, as well as changing the configuration such that the correction coefficient memory unit 150-4 stores a correction coefficient calculated by the correction coefficient calculation unit 162. The present embodiment is different from the first to the third embodiments which store the correction coefficient in the correction coefficient memory unit in advance, as the wireless communication apparatus itself calculates the correction coefficient at a timing of correction based on a distribution of the reception channel coefficients calculated from the reception channel coefficients, according to the present embodiment.

The reception channel coefficient memory unit 160 stores reception channel coefficients at reception (reception channel coefficients at a plurality of reception times) calculated by each of the reception channel coefficient calculation units 120-1 and 120-2 to 120-n.

The reception channel coefficient distribution calculation unit 161 calculates the distribution of reception channel coefficients based on a plurality of reception channel coefficients at reception stored in the reception channel coefficient memory unit 160.

The correction coefficient calculation unit 162 calculates the correction coefficient for correcting transmission channel coefficients at transmission calculated by the transmission channel coefficient calculation units 140-1 and 140-2 to 140-n, based on the distribution of reception channel coefficients calculated by the reception channel coefficient distribution calculation unit 161. The correction coefficient calculation unit 162 calculates the correction coefficient which corresponds to at least one of the followings: “a correction coefficient for more reducing the absolute value of the transmission channel coefficient at transmission calculated by each of the transmission channel coefficient calculation units 140-1 and 140-2 to 140-n, based on a larger variation of the absolute value of the reception channel coefficient at reception (variation of the absolute value including the positive sign and the negative sign)”, “a correction coefficient for correcting the phase of the transmission channel coefficients at transmission calculated by each of the transmission channel coefficient calculation units 140-1 and 140-2 to 140-n, in the same direction as the direction of the phase variation of the reception channel coefficient at reception (phase variation including the positive sign and the negative sign)”, and “a correction coefficient for more reducing the absolute value of the transmission channel coefficient at transmission calculated by each of the transmission channel coefficient calculation units 140-1 and 140-2 to 140-n, based on a larger absolute value of the reception channel coefficient at reception calculated by the reception channel coefficient calculation unit”.

The transmission channel coefficient correction units 170-41 and 170-42 to 170-4n correct the transmission channel coefficients at transmission calculated by the transmission channel coefficient calculation units 140-1 and 140-2 to 140-n, respectively, using the correction coefficient calculated based on the distribution of the reception channel coefficients stored in the correction coefficient memory unit 150-4.

According to the fourth embodiment, it is possible to reduce the calculation error (estimation error) of the transmission channel coefficient, by correcting the transmission channel coefficient at transmission calculated (estimated) by the extrapolation (the linear extrapolation, for example) based on the variation of the reception channel coefficient at reception by using the correction coefficient based on the distribution of the reception channel coefficients at reception calculated by the correction coefficient calculation unit 162. Thereby, even under circumstances with the significant fluctuation of the channel coefficient because of rapid movement of the counterpart wireless communication apparatus (terminal), it is possible to reduce the calculation error (estimation error) of the transmission channel coefficient, which improves calculation accuracy (estimation accuracy) of the transmission channel coefficient at transmission. Accordingly, it is possible to obtain good communication quality by preventing deterioration of communication quality caused by the fluctuation of the channel coefficient because of rapid movement and the likes of the counterpart wireless communication apparatus (terminal).

It is to be understood that the extrapolation used for calculation of the transmission channel coefficients by the transmission channel coefficient calculation units 140-1 and 140-2 to 140-n is not limited to “the linear extrapolation” but may be other extrapolation methods.

### Fifth Embodiment

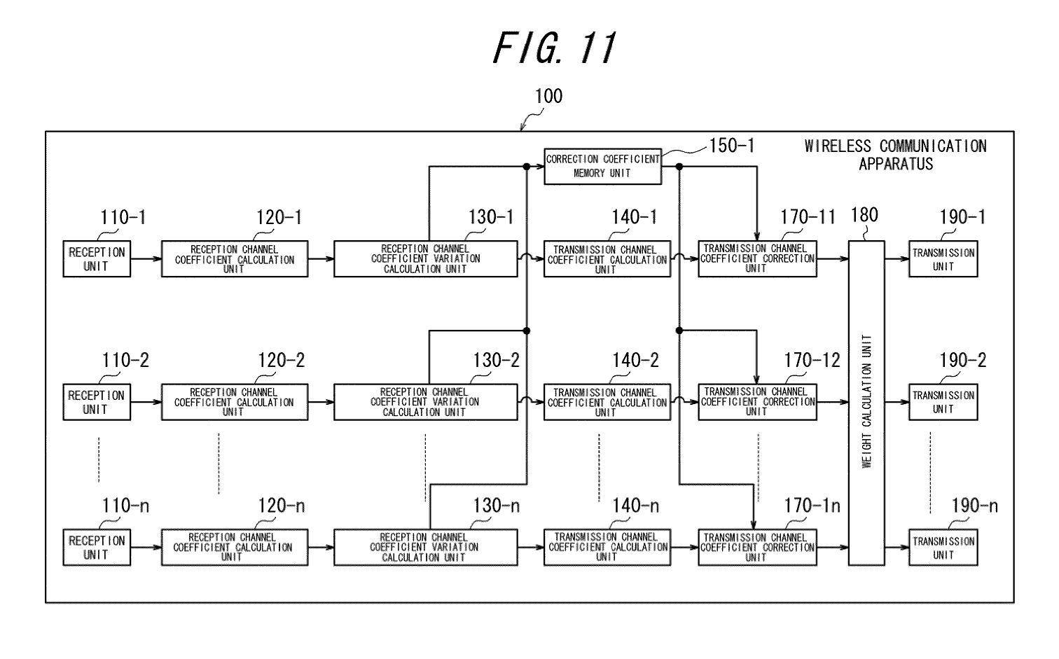

FIG. 11 is a block diagram illustrating a schematic constitution of a wireless communication apparatus according to a fifth embodiment applying the wireless communication method of the present invention. A wireless communication apparatus 100 according to the present embodiment is a wireless communication apparatus (hereinafter referred to also as a base station) having a plurality of antennas (not shown). The wireless communication apparatus 100 is provided with reception units 110-1 and 110-2 to 110-n for receiving radio signals transmitted from a counterpart wireless communication apparatus (not shown, hereinafter referred to also as a terminal) via the plurality of antennas, reception channel coefficient calculation units 120-1 and 120-2 to 120-n for calculating reception channel coefficients in a reception frequency band (reception channel coefficients in the reception frequency band of the respective plurality of antennas) in relation to the counterpart wireless communication apparatus based on the signals received by the reception units 110-1 and 110-2 to 110-n, transmission channel coefficient variation calculation units 130-1 and 130-2 to 130-n for calculating variations of the reception channel coefficients in the reception frequency band calculated by the reception channel coefficient calculation units 120-1 and 120-2 to 120-n (wherein the variation includes a variation of an absolute value of the reception channel coefficient in a frequency direction and a variation of a phase of the reception channel coefficient in the frequency direction), transmission channel coefficient calculation units 140-1 and 140-2 to 140-n for calculating (estimating) transmission channel coefficients in a transmission frequency band (transmission channel coefficients in the transmission frequency band of the respective plurality of antennas) by the extrapolation (the linear extrapolation, for example) in relation to the counterpart wireless communication apparatus based on the variations of the reception channel coefficients in the reception frequency band calculated by the reception channel coefficient variation calculation units 130-1 and 130-2 to 130-n, a correction coefficient memory unit 150-1 for storing a correction coefficient for correcting the transmission channel coefficients in the transmission frequency band calculated by the transmission channel coefficient calculation units 140-1 and 140-2 to 140-n, transmission channel coefficient correction units 170-11 and 170-12 to 170-1n for correcting the transmission channel coefficients in the transmission frequency band calculated by the transmission channel coefficient calculation units 140-1 and 140-2 to 140-n, a weight calculation unit 180 for calculating weights based on the transmission channel coefficients corrected by the transmission channel coefficient correction units 170-11 and 170-12 to 170-1n, and transmission units 190-1 and 190-2 to 190-n for transmitting radio signals, based on the transmission channel coefficients corrected by the transmission channel coefficient correction units 170-11 and 170-12 to 170-1n and the weights calculated by the weight calculation unit 180, via the plurality of antennas.

It is to be noted that although the wireless communication apparatus (base station) of the present invention and the wireless communication method of the present invention are preferably applicable to a system in which the transmission frequency band and the reception frequency band are different from each other (for example, FDD system; Frequency Division Duplex system), the wireless communication apparatus and the wireless communication method of the present invention are not limited to the above system but applicable to other systems.

The correction coefficient memory unit 150-1 stores the correction coefficient based on the variations of reception channel coefficients in the reception frequency band calculated by the reception channel coefficient variation calculation units 130-1 and 130-2 to 130-n, for correcting the transmission channel coefficients in the transmission frequency band calculated by the transmission channel coefficient calculation units 140-1 and 140-2 to 140-n.

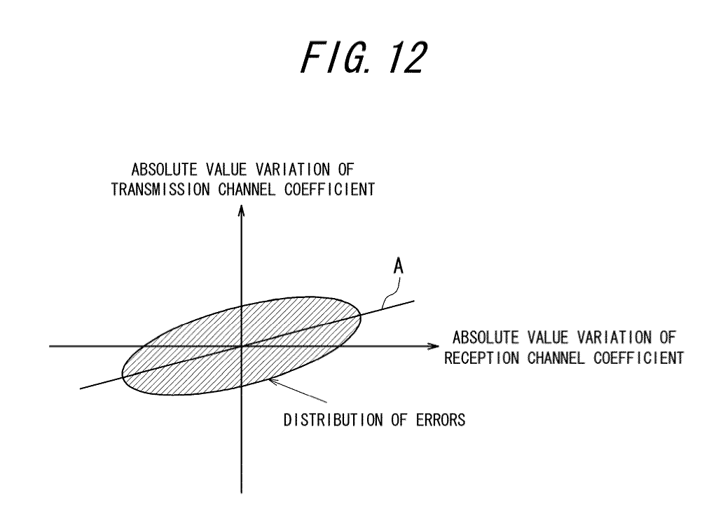

According to the present embodiment, the variation of the absolute value of the reception channel coefficient in the reception frequency band in the frequency direction (variation of the absolute value in the frequency direction including the positive sign and the negative sign, which means that the variation of the absolute value has the plus sign or the minus sign, and the frequency directing from the reception frequency band to the transmission frequency band is defined as positive, in this case) is used as the variation of the reception channel coefficient in the reception frequency band. In addition, according to the present embodiment, the slope of the approximate straight line (derivative) A shown in FIG. 12 is used as the correction coefficient, which corresponds to “a correction coefficient for more reducing the absolute value of the transmission channel coefficient in the transmission frequency band calculated by each of the transmission channel coefficient calculation units 140-1 and 140-2 and 140-n, based on a larger variation of the absolute value of the reception channel coefficient in the reception frequency band in the frequency direction”.

The transmission channel coefficient correction units 170-11 and 170-12 to 170-1n correct the transmission channel coefficients at transmission calculated by the transmission channel coefficient calculation units 140-1 and 140-2 and 140-n, using the correction coefficient based on the variation of the reception channel coefficient in the reception frequency band (in this case, the variation of the absolute value of the reception channel coefficient in the reception frequency band in the frequency direction) and stored in the correction coefficient memory unit 150-1.

Next, the correcting operation of the transmission channel coefficient according to the fifth embodiment is explained.

Under circumstances with a number of scattering objects such as in the urban area, the reception channel coefficient in the reception frequency band between the wireless communication apparatus (base station) 100 and the counterpart wireless communication apparatus (terminal) varies significantly in the frequency direction as being influenced by frequency selective fading. When the variation of the reception channel coefficient in the reception frequency band is adequately small, the transmission channel coefficient in the transmission frequency band, which is estimated from the variation of the reception channel coefficient in the reception frequency band by use of the linear extrapolation, is well matched with an original channel coefficient in the transmission frequency band. With significant influence by the frequency selective fading, however, the transmission channel coefficient in the transmission frequency band calculated (estimated) by the linear extrapolation departs far from the original transmission channel coefficient in the transmission frequency band, causing a significant calculation error (estimation error).

The following is an explanation of a relationship between the calculation error (estimation error) of the transmission channel coefficient and the reception channel coefficient in the reception frequency band, based on FIG. 12. In FIG. 12, the horizontal axis indicates the variation of the absolute value component of the reception channel coefficient in the reception frequency band and the vertical axis indicates the error between the absolute component of the transmission channel coefficient in the transmission frequency band calculated (estimated) by the linear extrapolation stated above and the absolute value component of the original transmission channel coefficient in the transmission frequency band. The oval area indicates a distribution of errors of absolute values of the transmission channel coefficients. The approximate straight line A shown in FIG. 12 can be obtained by assuming that there is a linear relationship between the error and the variation of the absolute value of the reception channel coefficient in the reception frequency band as shown in FIG. 12.

It is possible to calculate (estimate) the transmission channel coefficients in the transmission frequency band highly accurately, by storing the slope of the approximate straight line A (derivative) as the correction coefficient in the correction coefficient memory unit 150-1 in advance and using the correction coefficient, together with the variations of the absolute values of the reception channel coefficients in the reception frequency band calculated by the reception channel coefficient variation calculation units 130-1 and 130-2 to 130-n, for correction of the transmission channel coefficients by the transmission channel coefficient correction units 170-11 and 170-12 to 170-1n. This correction uses the following formula (6).

$$\begin{matrix}[ Formula 6 ] & \\ \vert {H}_{TX} \vert = \vert {\hat{H}}_{TX} \vert - α \frac{\partial \vert {H}_{RX} \vert}{\partial f} & ( 6 )\end{matrix}$$

provided that
   |H_{TX}|: absolute value of transmission channel coefficient after correction
   |Ĥ_{TX}|: absolute value of transmission channel coefficient before correction
α: correction coefficient to variation of absolute value of reception channel coefficient in reception frequency band

$$\frac{\partial \vert {H}_{RX} \vert}{\partial f} \text{:}$$

variation of absolute value of reception channel coefficient in reception frequency band

According to the fifth embodiment, it is possible to reduce the calculation error (estimation error) of the transmission channel coefficient by correcting the absolute value of the transmission channel coefficient in the transmission frequency band calculated (estimated) by the extrapolation (the linear extrapolation, for example) based on the variation of the reception channel coefficient in the reception frequency band, by use of the correction coefficient based on the variation of the reception channel coefficient in the reception frequency band shown in FIG. 12. Thereby, even under circumstances with the frequency selective fading, it is possible to reduce the calculation error (estimation error) of the transmission channel coefficient, which improves calculation accuracy (estimation accuracy) of the transmission channel coefficient in the transmission frequency band. Accordingly, it is possible to obtain good communication quality by preventing deterioration of the quality of adaptive control of the transmission channel coefficient in the transmission frequency band caused by the frequency selective fading.

### Sixth Embodiment

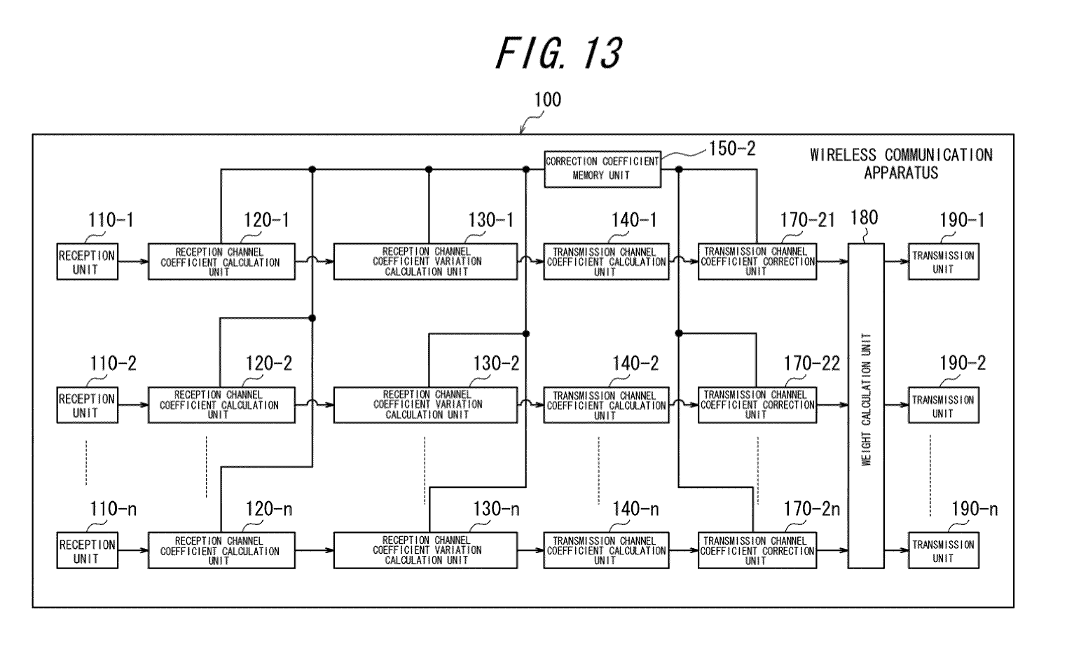

FIG. 13 is a block diagram illustrating a schematic constitution of a wireless communication apparatus according to a sixth embodiment applying the wireless communication method of the present invention. A wireless communication apparatus 100 according to the present embodiment has the same constitution as the wireless communication apparatus 100 of the fifth embodiment, except for replacing the correction coefficient memory unit 150-1 with the correction coefficient memory unit 150-2 and replacing the transmission channel coefficient correction units 170-11 and 170-12 to 170-1n with the transmission channel coefficient correction units 170-21 and 170-22 to 170-2n.

The correction coefficient memory unit 150-2 stores correction coefficients based on the variations of the reception channel coefficients in the reception frequency band calculated by the reception channel coefficient variation calculation units 130-1 and 130-2 to 130-n and the reception channel coefficients in the reception frequency band calculated by the reception channel coefficient calculation units 120-1 and 120-2 to 120-n, for correcting the transmission channel coefficients in the transmission frequency band calculated by the transmission channel coefficient calculation units 140-1 and 140-2 to 140-n.

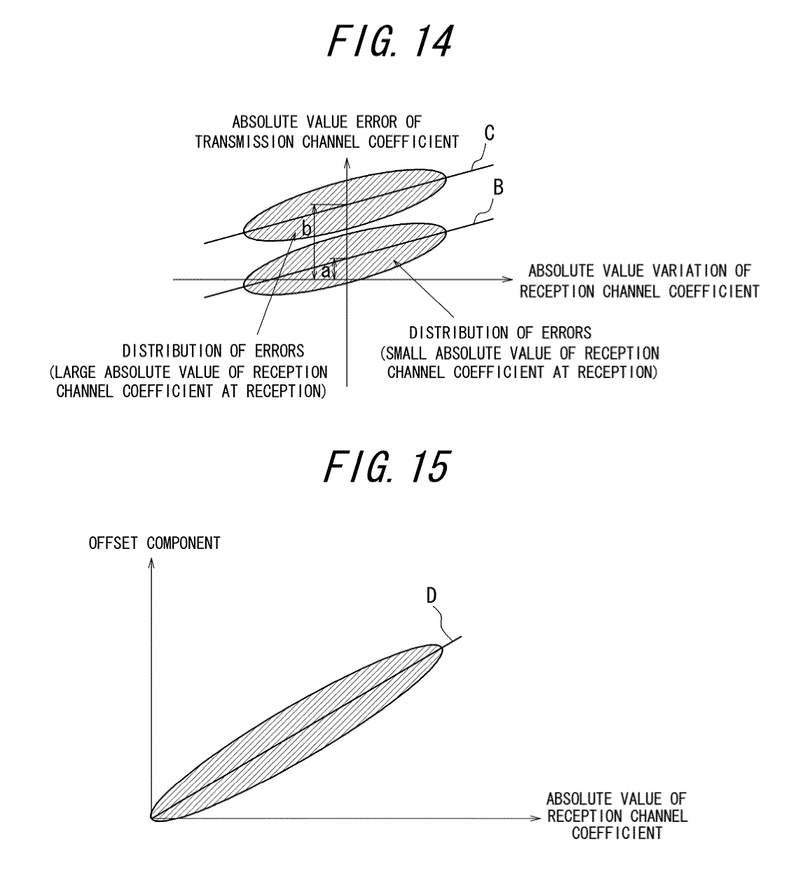

According to the present embodiment, the variation of the absolute value of the reception channel coefficient in the reception frequency band in the frequency direction (variation of the absolute value in the frequency direction including the positive sign and the negative sign, which means that the variation of the absolute value has the plus sign or the minus sign, and the frequency directing from the reception frequency band to the transmission frequency band is defined as positive, in this case) is used as the variation of the reception channel coefficient in the reception frequency band. In addition, according to the present embodiment, slopes of approximate straight lines (derivatives) B and C in FIG. 14 and a slope of approximate straight line D in FIG. 15 are used as the correction coefficients, which correspond to “a correction coefficient for more reducing the absolute value of the transmission channel coefficient in the transmission frequency band calculated by each of the transmission channel coefficient calculation units 140-1 and 140-2 and 140-n, based on a larger variation of the absolute value of the reception channel coefficient in the reception frequency band in the frequency direction” and “a correction coefficient for more reducing the absolute value of the transmission channel coefficients in the transmission frequency band calculated by each of the transmission channel coefficient calculation units 140-1 and 140-2 and 140-n, based on a larger absolute value of the reception channel coefficient in the reception frequency band calculated by each of the reception channel coefficient calculation units 120-1 and 120-2 to 120-n”. In FIG. 14, the distribution of errors in the lower part indicates a distribution of absolute value errors of the transmission channel coefficients in the transmission frequency band when absolute values of the reception channel coefficients in the reception frequency band are small, while the distribution of errors in the upper part indicates a distribution of absolute value errors of the transmission channel coefficients in the transmission frequency band when the absolute values of the reception channel coefficients in the reception frequency band are large.

The transmission channel coefficient correction units 170-21 and 170-22 to 170-2n correct the transmission channel coefficients in the transmission frequency band calculated by the transmission channel coefficient calculation units 140-1 and 140-2 to 140-n, using the correction coefficients based on the variation of the reception channel coefficient in the reception frequency band and the reception channel coefficient in the reception frequency band, stored in the correction coefficient memory unit 150.

Next, the correcting operation of the transmission channel coefficient according to the sixth embodiment is explained.

Under circumstances with a number of scattering objects such as in the urban area, the reception channel coefficient in the reception frequency band between the wireless communication apparatus (base station) 100 and the counterpart wireless communication apparatus (terminal) varies significantly in the frequency direction as being influenced by the frequency selective fading. When the variation of the reception channel coefficient in the reception frequency band is adequately small, the transmission channel coefficient in the transmission frequency band, which is estimated from the variation of the reception channel coefficient in the reception frequency band by use of the linear extrapolation, is well matched with the original channel coefficient in the transmission frequency band. With significant influence by the frequency selective fading, however, the transmission channel coefficient in the transmission frequency band calculated (estimated) by the linear extrapolation departs far from the original transmission channel coefficient in the transmission frequency band, causing a significant calculation error (estimation error).

The following is a description of the relationship between the calculation error (estimation error) of the transmission channel coefficient and the reception channel coefficient in the reception frequency band, based on FIG. 14. In FIG. 14, the horizontal axis indicates the variation of the absolute value component of the reception channel coefficient in the reception frequency band and the vertical axis indicates the error between the absolute value component of the transmission channel coefficient in the transmission frequency band calculated (estimated) by the linear extrapolation stated above and the absolute value component of the original transmission channel coefficient in the transmission frequency band. One of two oval areas indicates a distribution of absolute value errors of the transmission channel coefficients when absolute values of the reception channel coefficients in the reception frequency band are small, while the other indicates a distribution of absolute value errors of the transmission channel coefficients when the absolute values of the reception channel coefficients in the reception frequency band are large. Approximate straight lines B, C shown in FIG. 14 can be obtained by assuming that there is a linear relationship between the error and the variation of the absolute value of the reception channel coefficient in the reception frequency band as shown in FIG. 14.

FIG. 15 shows a relationship between offset components (a and b in FIG. 14 indicating the displacement from the approximate straight line passing the origin) of the approximate straight lines B, C and the absolute value of the reception channel coefficient in the reception frequency band. An approximate straight line D in FIG. 15 can be obtained by assuming that there is a linear relationship between the absolute value of the reception channel coefficient in the reception frequency band and the offset component, as shown in FIG. 15.

It is possible to calculate (estimate) the transmission channel coefficients in the transmission frequency band highly accurately, by storing the slopes (derivatives) of the approximate straight lines B, C and D as the correction coefficients in the correction coefficient memory unit 150-2 in advance and using the correction coefficients, together with the variations of absolute values of the reception channel coefficients in the reception frequency band calculated by the reception channel coefficient variation calculation units 130-1 and 130-2 to 130-n and the reception channel coefficients in the reception frequency band calculated by the reception channel coefficient calculation units 120-1 and 120-2 to 120-n, for correction of the transmission channel coefficients by the transmission channel coefficient correction units 170-21 and 170-22 to 170-2n. This correction uses the following formula (7).

$$\begin{matrix}[ Formula 7 ] & \\ \vert {H}_{TX} \vert = \vert {\hat{H}}_{TX} \vert - α \frac{\partial \vert {H}_{RX} \vert}{\partial f} - β \vert {H}_{RX} \vert & ( 7 )\end{matrix}$$

provided that
   |H_{TX}|: absolute value of transmission channel coefficient after correction
   |Ĥ_{TX}|: absolute value of transmission channel coefficient before correction
α: correction coefficient to variation of absolute value of reception channel coefficient in reception frequency band

$$\frac{\partial \vert {H}_{RX} \vert}{\partial f} \text{:}$$

variation of absolute value of reception channel coefficient in reception frequency band
β: correction coefficient to absolute value of reception channel coefficient in reception frequency band
   |H_{RX}|: absolute value of reception channel coefficient in reception frequency band

According to the sixth embodiment, it is possible to reduce the calculation error (estimation error) of the transmission channel coefficient, by correcting the absolute value of the transmission channel coefficient in the transmission frequency band calculated (estimated) by the extrapolation (the linear extrapolation, for example) based on the variation of the reception channel coefficient in the reception frequency band, by using the correction coefficients based on the variation of the reception channel coefficient in the reception frequency band and the reception channel coefficient in the reception frequency band shown in FIGS. 14 and 15. Thereby, even under circumstances with the frequency selective fading, it is possible to reduce the calculation error (estimation error) of the transmission channel coefficient, which improves calculation accuracy (estimation accuracy) of the transmission channel coefficient in the transmission frequency band. Accordingly, it is possible to obtain good communication quality by preventing deterioration of the quality of adaptive control of transmission channel coefficient in the transmission frequency band caused by the frequency selective fading.

### Seventh Embodiment

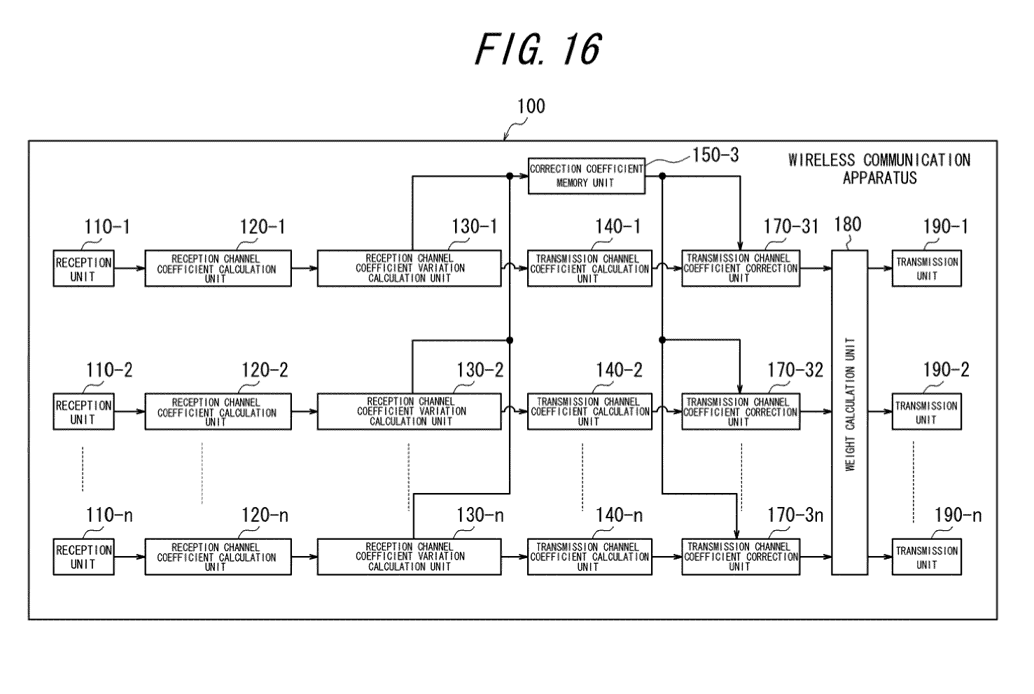

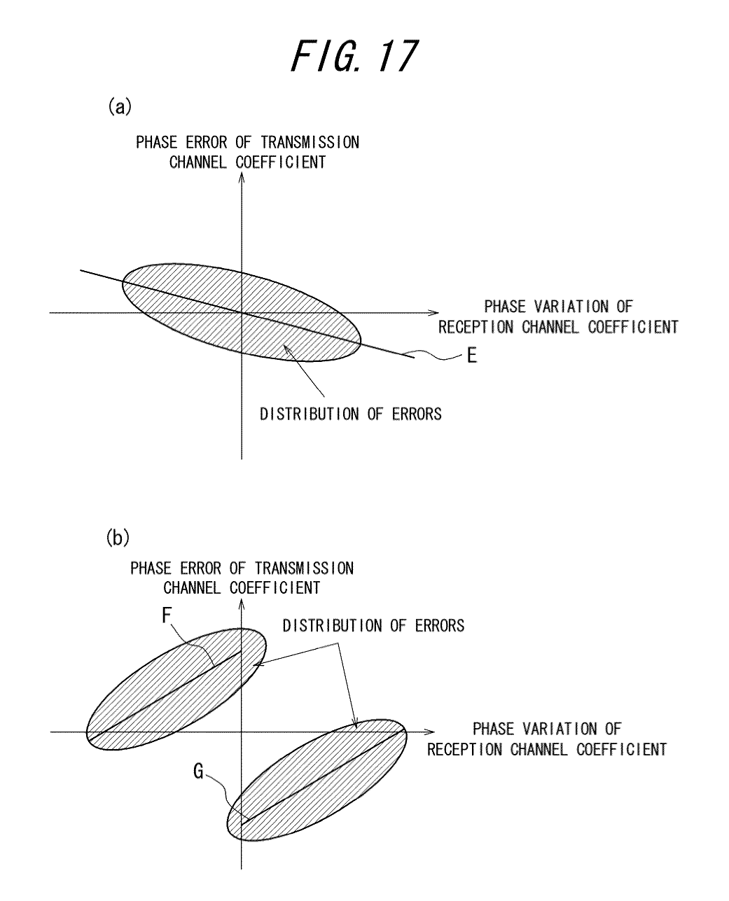

FIG. 16 is a block diagram illustrating a schematic constitution of a wireless communication apparatus according to a seventh embodiment applying the wireless communication method of the present invention. A wireless communication apparatus 100 according to the present embodiment has the same constitution as the wireless communication apparatus 100 of the fifth embodiment, except for replacing the correction coefficient memory unit 150-1 with the correction coefficient memory unit 150-3 and also replacing the transmission channel coefficient correction units 170-11 and 170-12 to 170-1n with the transmission channel coefficient correction units 170-31 and 170-32 to 170-3n.

The correction coefficient memory unit 150-3 stores the correction coefficient based on the variation of the reception channel coefficients in the reception frequency band calculated by the reception channel coefficient variation calculation units 130-1 and 130-2 to 130-n, for correcting the transmission channel coefficients in the transmission frequency band calculated by the transmission channel coefficient calculation units 140-1 and 140-2 to 140-n.

According to the present embodiment, the phase variation of the reception channel coefficient in the reception frequency band in the frequency direction (the frequency directing from the reception frequency band to the transmission frequency band is defined as positive, whereas the frequency directing from the transmission frequency band to the reception frequency band is defined as negative) is used as the variation of the reception channel coefficient in the reception frequency band. In addition, according to the present embodiment, slopes (derivatives) of approximate straight lines E, F and G shown in FIGS. 17(a), (b) are used as the correction coefficient, which corresponds to “a correction coefficient for correcting the phase of the transmission channel coefficient in the transmission frequency band calculated by each of the transmission channel coefficient calculation units 140-1 and 140-2 to 140-n, in the same direction as the direction of the phase variation of the reception channel coefficient in the reception frequency band in the frequency direction”.

The transmission channel coefficient correction units 170-31 and 170-32 to 170-3n correct the transmission channel coefficients in the transmission frequency band calculated by the transmission channel coefficient calculation units 140-1 and 140-2 to 140-n, by using the correction coefficient based on the variation of the reception channel coefficient in the reception frequency band (in this case, the phase variation of the reception channel coefficient in the reception frequency band in the frequency direction) and stored in the correction coefficient memory unit 150-3.

Next, the correcting operation of the transmission channel coefficient according to the seventh embodiment is explained.

Under circumstances with a number of scattering objects such as in the urban area, the reception channel coefficient in the reception frequency band between the wireless communication apparatus (base station) 100 and the counterpart wireless communication apparatus (terminal) varies significantly in the frequency direction as being influenced by the frequency selective fading. When the variation of the reception channel coefficient in the reception frequency band is adequately small, the transmission channel coefficient in the transmission frequency band, which is estimated from the variation of the reception channel coefficient in the reception frequency band by use of the linear extrapolation, is well matched with the original channel coefficient in the transmission frequency band. With significant influence by the frequency selective fading, however, the transmission channel coefficient in the transmission frequency band calculated (estimated) by the linear extrapolation departs far from the original transmission channel coefficient in the transmission frequency band, causing a significant calculation error (estimation error).

The following is a description of the relationship between the calculation error (estimation error) of the transmission channel coefficient and the reception channel coefficient in the reception frequency band, based on FIGS. 17(a), (b). In FIGS. 17(a), (b), the horizontal axis indicates the variation of a phase component of the reception channel coefficient in the reception frequency band and the vertical axis indicates the error between the phase component of the transmission channel coefficient in the transmission frequency band calculated (estimated) by the linear extrapolation and the phase component of the original transmission channel coefficient in the transmission frequency band. FIG. 17(a) illustrates a case where the phase variation of the reception channel coefficient increases and the oval area indicates a distribution of phase errors of the transmission channel coefficients. FIG. 17(b) illustrates a case where the phase variation of the reception channel coefficient decreases and one of two oval areas indicates a distribution of phase errors of the transmission channel coefficients when the phase errors are positive, whereas the other indicates a distribution of phase errors of the transmission channel coefficients when the phase errors are negative. The approximate straight line E shown in FIG. 17(a) can be obtained by assuming that there is a linear relationship between the error and the phase variation of the reception channel coefficient in the reception frequency band as shown in FIG. 17(a).

It is possible to calculate (estimate) the transmission channel coefficients in the transmission frequency band highly accurately, by storing the slope (derivative) of the approximate straight line E as the correction coefficient in the correction coefficient memory unit 150-3 in advance and using the correction coefficient, together with phase variations of the reception channel coefficients in the reception frequency band calculated by the reception channel coefficient variation calculation units 130-1 and 130-2 to 130-n, for correction of the transmission channel coefficients by the transmission channel coefficient correction units 170-31 and 170-32 to 170-3n. This correction uses the following formula (8).

$$\begin{matrix}[ Formula 8 ] & \\ arg ( {H}_{TX} ) = arg ( {\hat{H}}_{TX} ) - α \frac{\partial arg ( {H}_{RX} )}{\partial f} & ( 8 )\end{matrix}$$

provided that
arg(H_{TX}): phase of transmission channel coefficient after correction
arg(Ĥ_{TX}): phase of transmission channel coefficient before correction
α: correction coefficient to phase variation of reception channel coefficient in reception frequency band (when variation of absolute value of reception channel coefficient in reception frequency band in frequency direction increases)

$$\frac{\partial arg ( {H}_{RX} )}{\partial f} \text{:}$$

phase variation of reception channel coefficient in reception frequency band

In addition, approximate straight lines F and G shown in FIG. 17(b) can be obtained by assuming that there is a linear relationship between the error and the phase variation of the reception channel coefficient in the reception frequency band as shown in FIG. 17(b).

It is possible to calculate (estimate) the transmission channel coefficients in the transmission frequency band highly accurately, by storing the slopes of the approximate straight lines F and G (derivatives) as the correction coefficient in the correction coefficient memory unit 150-3 in advance and using the correction coefficient, together with phase variations of the reception channel coefficients in the reception frequency band calculated by the reception channel coefficient variation calculation units 130-1 and 130-2 to 130-n, for correction of the transmission channel coefficients by the transmission channel coefficient correction units 170-31 and 170-32 to 170-3n. This correction uses the following formulas (9), (10).

$$\begin{matrix}[ Formula 9 ] & \\ arg ( {H}_{TX} ) = arg ( {\hat{H}}_{TX} ) + α \frac{\partial arg ( {H}_{RX} )}{\partial f} - β & ( 9 )\end{matrix}$$

(when phase variation of reception channel coefficient in reception frequency band in frequency direction increases)

$$\begin{matrix}[ Formula 10 ] & \\ arg ( {H}_{TX} ) = arg ( {\hat{H}}_{TX} ) - α \frac{\partial arg ( {H}_{RX} )}{\partial f} + β & ( 10 )\end{matrix}$$

(when phase variation of reception channel coefficient in reception frequency band in frequency direction decreases)
provided that
arg(H_{TX}): phase of transmission channel coefficient after correction
arg(Ĥ_{TX}): phase of transmission channel coefficient before correction
α: correction coefficient to phase variation of reception channel coefficient in reception frequency band (when variation of absolute value of reception channel coefficient in reception frequency band decreases)

$$\frac{\partial arg ( {H}_{RX} )}{\partial f} \text{:}$$

phase variation of reception channel coefficient in reception frequency band
β: offset of correction to phase variation of reception channel coefficient in reception frequency band (when variation of absolute value of reception channel coefficient in reception frequency band decreases)

According to the seventh embodiment, it is possible to reduce the calculation error (estimation error) of the transmission channel coefficient by correcting the phase of the transmission channel coefficient in the transmission frequency band calculated (estimated) by the extrapolation (the linear extrapolation, for example) based on the variation of the reception channel coefficient in the reception frequency band, by use of the correction coefficient based on the variation of the reception channel coefficient in the reception frequency shown in FIGS. 17(a), (b). Thereby, even under circumstances with the frequency selective fading, it is possible to reduce the calculation error (estimation error) of the transmission channel coefficient, which improves calculation accuracy (estimation accuracy) of the transmission channel coefficient in the transmission frequency band. Accordingly, it is possible to obtain good communication quality by preventing deterioration of the quality of adaptive control of the transmission channel coefficient in the transmission frequency band caused by the frequency selective fading.

### Eighth Embodiment

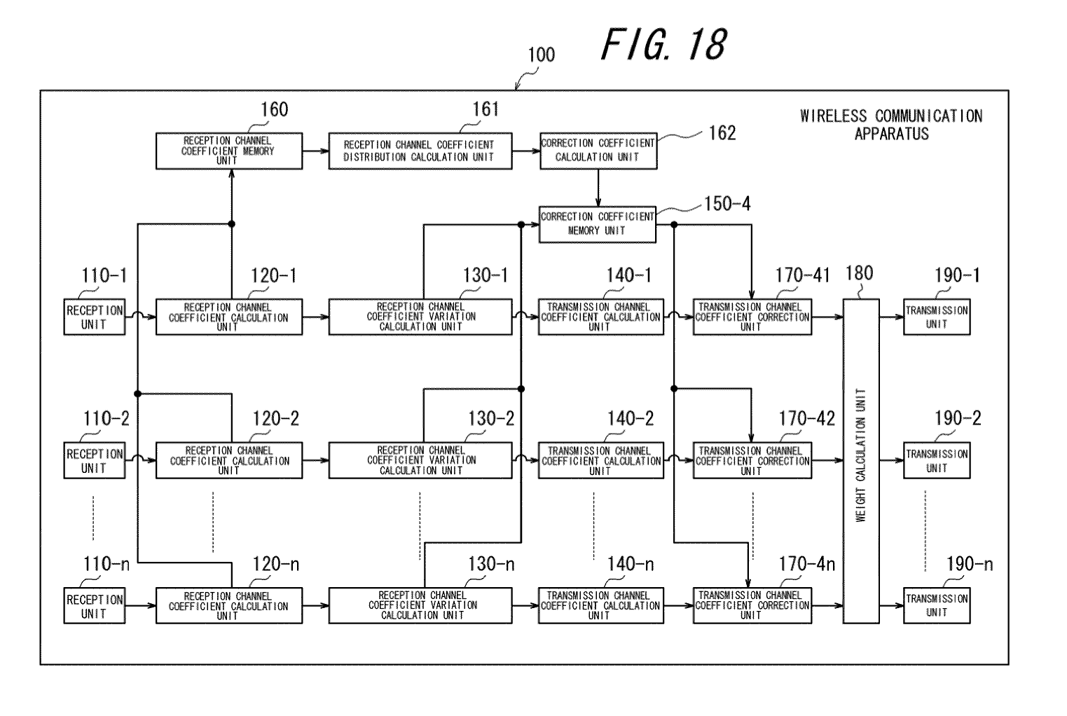

FIG. 18 is a block diagram illustrating a schematic constitution of a wireless communication apparatus according to an eighth embodiment applying the wireless communication method of the present invention. A wireless communication apparatus 100 according to the present embodiment has the same constitution as the wireless communication apparatus 100 of the fifth embodiment, except for having the reception channel coefficient memory unit 160, the reception channel coefficient distribution calculation unit 161 and the correction coefficient calculation unit 162 in addition and replacing the correction coefficient memory unit 150-1 with the correction coefficient memory unit 150-4 and also replacing the transmission channel coefficient correction units 170-11 and 170-12 to 170-1n with the transmission channel coefficient correction units 170-41 and 170-42 to 170-4n, as well as changing the configuration such that the correction coefficient memory unit 150-4 stores a correction coefficient calculated by the correction coefficient calculation unit 162. The present embodiment is different from the fifth to the seventh embodiments which store the correction coefficient in the correction coefficient memory unit in advance, as the wireless communication apparatus itself calculates the correction coefficient at the timing of correction based on a distribution of reception channel coefficients in the frequency direction calculated from the reception channel coefficients, according to the present embodiment.

The reception channel coefficient memory unit 160 stores reception channel coefficients in the reception frequency band (a plurality of reception channel coefficients in the reception frequency band) calculated by the reception channel coefficient calculation units 120-1 and 120-2 to 120-n, respectively.

The reception channel coefficient distribution calculation unit 161 calculates the distribution of the reception channel coefficients in the frequency direction based on the plurality of reception channel coefficients in the reception frequency band stored in the reception channel coefficient memory unit 160.

The correction coefficient calculation unit 162 calculates the correction coefficient for correcting the transmission channel coefficients in the transmission frequency band calculated by the transmission channel coefficient calculation units 140-1 and 140-2 to 140-n, based on the distribution of the reception channel coefficients in the frequency direction calculated by the reception channel coefficient distribution calculation unit 161. The correction coefficient calculation unit 162 calculates the correction coefficient which corresponds to at least one of the followings: “a correction coefficient for more reducing the absolute value of the transmission channel coefficient in the transmission frequency band calculated by each of the transmission channel coefficient calculation units 140-1 and 140-2 to 140-n, based on a larger variation of the absolute value of the reception channel coefficient in the reception frequency band in the frequency direction (the variation of the absolute value in the frequency direction including the positive sign and the negative sign, which means that the variation of the absolute value has the plus sign or the minus sing and, in this case, the frequency directing from the reception frequency band to the transmission frequency band is defined as positive)”; “a correction coefficient for correcting the phase of the transmission channel coefficient in the transmission frequency band calculated by each of the transmission channel coefficient calculation units 140-1 and 140-2 to 140-n, in the same direction as the direction of the phase variation of the reception channel coefficient in the reception frequency band in the frequency direction (the frequency directing from the reception frequency band to the transmission frequency band is defined as positive, whereas the frequency directing from the transmission frequency band to the reception frequency band is defined as negative)”; and “a correction coefficient for more reducing the absolute value of the transmission channel coefficient in the transmission frequency band calculated by each of the transmission channel coefficient calculation units 140-1 and 140-2 to 140-n, based on a larger absolute value of the reception channel coefficient in the reception frequency band calculated by the reception channel coefficient calculation unit”.

The transmission channel coefficient correction units 170-41 and 170-42 to 170-4n correct the transmission channel coefficients in the transmission frequency band calculated by the transmission channel coefficient calculation units 140-1 and 140-2 to 140-n, using the correction coefficient calculated based on the distribution of the reception channel coefficients in the frequency direction stored in the correction coefficient memory unit 150-4.

According to the eighth embodiment, it is possible to reduce the calculation error (estimation error) of the transmission channel coefficient by correcting the transmission channel coefficient in the transmission frequency band calculated (estimated) by the extrapolation (the linear extrapolation, for example) based on the variation of the reception channel coefficient in the reception frequency band, by use of the correction coefficient based on the distribution of the reception channel coefficients in the frequency direction calculated by the correction coefficient calculation unit 162. Thereby, even under circumstances with the frequency selective fading, it is possible to reduce the calculation error (estimation error) of the transmission channel coefficient, which improves calculation accuracy (estimation accuracy) of the transmission channel coefficient in the transmission frequency band. Accordingly, it is possible to obtain good communication quality by preventing deterioration of the quality of adaptive control of the transmission channel coefficient in the transmission frequency band caused by the frequency selective fading.

It is to be understood that the extrapolation used for calculation of the transmission channel coefficients by the transmission channel coefficient calculation units 140-1 and 140-2 to 140-n is not limited to “the linear extrapolation” but may be other extrapolation methods.

1. A wireless communication apparatus having a plurality of antennas comprising:
a reception channel coefficient calculation unit for calculating a reception channel coefficient at reception, for each of the plurality of antennas;
a transmission channel coefficient calculation unit for calculating a transmission channel coefficient at transmission, for each of the plurality of antennas, by extrapolation based on a variation of the reception channel coefficient at reception calculated by the reception channel coefficient calculation unit; and
a correction unit for correcting the transmission channel coefficient at transmission calculated by the transmission channel coefficient calculation unit, using a correction coefficient based on the variation of the reception channel coefficient at reception.

2. The wireless communication apparatus according to claim 1, wherein the correction coefficient is a correction coefficient for more reducing an absolute value of the transmission channel coefficient at transmission calculated by the transmission channel coefficient calculation unit, based on a larger variation of an absolute value of the reception channel coefficient at reception.

3. The wireless communication apparatus according to claim 1, wherein the correction coefficient is a correction coefficient for correcting a phase of the transmission channel coefficient at transmission calculated by the transmission channel coefficient calculation unit in a same direction as a direction of a phase variation of the reception channel coefficient at reception.

4. The wireless communication apparatus according to claim 1, wherein the correction unit corrects the transmission channel coefficient at transmission calculated by the transmission channel coefficient calculation unit, further based on the reception channel coefficient at reception calculated by the reception channel coefficient calculation unit.

5. The wireless communication apparatus according to claim 1, wherein the correction coefficient is a correction coefficient for more reducing an absolute value of the transmission channel coefficient at transmission calculated by the transmission channel coefficient calculation unit, based on a larger absolute value of the reception channel coefficient at reception calculated by the reception channel coefficient calculation unit.

6. The wireless communication apparatus according to claim 1, further comprising a reception channel coefficient memory unit for storing a plurality of reception channel coefficients at reception calculated by the reception channel coefficient calculation unit, a reception channel coefficient distribution calculation unit for calculating a distribution of reception channel coefficients based on the plurality of reception channel coefficients at reception stored in the reception channel coefficient memory unit, and a correction coefficient calculation unit for calculating a correction coefficient for correcting the transmission channel coefficient at transmission calculated by the transmission channel coefficient calculation unit, based on the distribution of reception channel coefficients calculated by the reception channel coefficient distribution calculation unit,
wherein the correction unit corrects the transmission channel coefficient at transmission calculated by the transmission channel coefficient calculation unit based on the correction coefficient calculated by the correction coefficient calculation unit.

7. The wireless communication apparatus according to claim 6, wherein the correction coefficient calculation unit calculates a correction coefficient for more reducing an absolute value of the transmission channel coefficient at transmission calculated by the transmission channel coefficient calculation unit, based on a larger variation of an absolute value of the reception channel coefficient at reception.

8. The wireless communication apparatus according to claim 6, wherein the correction coefficient calculation unit calculates a correction coefficient for correcting a phase of the transmission channel coefficient at transmission calculated by the transmission channel coefficient calculation unit in a same direction as a direction of a phase variation of the reception channel coefficient at reception.

9. The wireless communication apparatus according to claim 6, wherein the correction coefficient calculation unit calculates a correction coefficient for more reducing an absolute value of the transmission channel coefficient at transmission calculated by the transmission channel coefficient calculation unit, based on a larger absolute value of the reception channel coefficient at reception calculated by the reception channel coefficient calculation unit.

10. A wireless communication apparatus having a plurality of antennas comprising:
a reception channel coefficient calculation unit for calculating a reception channel coefficient in a reception frequency band, for each of the plurality of antennas;
a transmission channel coefficient calculation unit for calculating a transmission channel coefficient in a transmission frequency band, for each of the plurality of antennas, by extrapolation based on a variation of the reception channel coefficient in the reception frequency band calculated by the reception channel coefficient calculation unit; and
a correction unit for correcting the transmission channel coefficient in the transmission frequency band calculated by the transmission channel coefficient calculation unit, using a correction coefficient based on the variation of the reception channel coefficient in the reception frequency band.

11. The wireless communication apparatus according to claim 10, wherein the correction coefficient is a correction coefficient for more reducing an absolute value of the transmission channel coefficient in the transmission frequency band calculated by the transmission channel coefficient calculation unit, based on a larger variation of an absolute value of the reception channel coefficient in the reception frequency band in a frequency direction.

12. The wireless communication apparatus according to claim 10, wherein the correction coefficient is a correction coefficient for correcting a phase of the transmission channel coefficient in the transmission frequency band calculated by the transmission channel coefficient calculation unit in a same direction as a direction of a phase variation of the reception channel coefficient in the reception frequency band in a frequency direction.

13. The wireless communication apparatus according to claim 10, wherein the correction unit corrects the transmission channel coefficient in the transmission frequency band calculated by the transmission channel coefficient calculation unit, further based on the reception channel coefficient in the reception frequency band calculated by the reception channel coefficient calculation unit.

14. The wireless communication apparatus according to claim 10, wherein the correction coefficient is a correction coefficient for more reducing an absolute value of the transmission channel coefficient in the transmission frequency band calculated by the transmission channel coefficient calculation unit, based on a larger absolute value of the reception channel coefficient in the reception frequency band calculated by the reception channel coefficient calculation unit.

15. The wireless communication apparatus according to claim 10, further comprising a reception channel coefficient memory unit for storing a plurality of reception channel coefficients in the reception frequency band calculated by the reception channel coefficient calculation unit, a reception channel coefficient distribution calculation unit for calculating a distribution of reception channel coefficients in a frequency direction based on the plurality of reception channel coefficients in the reception frequency band stored in the reception channel coefficient memory unit, and a correction coefficient calculation unit for calculating a correction coefficient for correcting the transmission channel coefficient in the transmission frequency band calculated by the transmission channel coefficient calculation unit, based on the distribution of reception channel coefficients in the frequency direction calculated by the reception channel coefficient distribution calculation unit,
wherein the correction unit corrects the transmission channel coefficient in the transmission frequency band calculated by the transmission channel coefficient calculation unit based on the correction coefficient calculated by the correction coefficient calculation unit.

16. The wireless communication apparatus according to claim 15, wherein the correction coefficient calculation unit calculates a correction coefficient for more reducing an absolute value of the transmission channel coefficient in the transmission frequency band calculated by the transmission channel coefficient calculation unit, based on a larger variation of an absolute value of the reception channel coefficient in the reception frequency band in the frequency direction.

17. The wireless communication apparatus according to claim 15, wherein the correction coefficient calculation unit calculates a correction coefficient for correcting a phase of the transmission channel coefficient in the transmission frequency band calculated by the transmission channel coefficient calculation unit in a same direction as a direction of a phase variation of the reception channel coefficient in the reception frequency band in the frequency direction.

18. The wireless communication apparatus according to claim 15, wherein the correction coefficient calculation unit calculates a correction coefficient for more reducing an absolute value of the transmission channel coefficient in the transmission frequency band calculated by the transmission channel coefficient calculation unit, based on a larger absolute value of the reception channel coefficient in the reception frequency band calculated by the reception channel coefficient calculation unit.

19. The wireless communication apparatus according to claim 10, wherein the wireless communication apparatus is used for a system in which the transmission frequency band and the reception frequency band are different from each other.

20. A wireless communication method for controlling wireless communication between a wireless communication apparatus having a plurality of antennas and a counterpart wireless communication apparatus comprising:
a reception channel coefficient calculation step for calculating a reception channel coefficient at reception, for each of the plurality of antennas;
a transmission channel coefficient calculation step for calculating a transmission channel coefficient at transmission, for each of the plurality of antennas, by extrapolation based on a variation of the reception channel coefficient at reception calculated at the reception channel coefficient calculation step; and
a correction step for correcting the transmission channel coefficient at transmission calculated at the transmission channel coefficient calculation step, using a correction coefficient based on the variation of the reception channel coefficient at reception.

21. A wireless communication method for controlling wireless communication between a wireless communication apparatus having a plurality of antennas and a counterpart wireless communication apparatus comprising:
a reception channel coefficient calculation step for calculating a reception channel coefficient in a reception frequency band, for each of the plurality of antennas;
a transmission channel coefficient calculation step for calculating a transmission channel coefficient in a transmission frequency band, for each of the plurality of antennas, by extrapolation based on a variation of the reception channel coefficient in the reception frequency band calculated at the reception channel coefficient calculation step; and
a correction step for correcting the transmission channel coefficient in the transmission frequency band calculated at the transmission channel coefficient calculation step, using a correction coefficient based on the variation of the reception channel coefficient in the reception frequency band.
